(19) United States
(12) Patent Application Publication
(10) Pub. No.: US 2006/0282498 A1
(43) Pub. Date: Dec. 14, 2006

(54) Sensor network system, method for data processing of a sensor network system

(75) Inventor: Keiro Muro, Koganei (JP)

Correspondence Address: Stanley P. Fisher;Reed Smith LLP, Suite 1400, 3110 Fairview Park Drive, Falls Church, VA, 22042-4503, US

(73) Assignee: Hitach, Ltd.

(21) Appl. No.: 11/210,736

(22) Filed: Aug. 25, 2005

(30) Foreign Application Priority Data
Jun. 9, 2005 (JP) 2005-169323

(51) Int. Cl. G06F 15/16

(52) U.S. Cl. 709/203

(57) ABSTRACT

An operation flow of each node is dynamically changed according to a user request or a situation. A client (205) includes: a step (415) of extracting a script for a lower node from scripts in which processing is preset for a plurality of nodes to distribute the script extracted to the lower node; a step of executing processing for a self node from the script; a step of causing the lower node to receive the script distributed to execute processing for the node; and a step 410 of causing the lower node to extract a script for a node lower than the self node from the scripts, and to distribute the extracted script to the lower node if the script for the lower node is present. Based on a script executed by each node, an event from a lowest sensor node is sent through an intermediate node to the client 205.

### CLAIM OF PRIORITY

The present application claims priority from Japanese application P2005-169323 filed on Jun. 9, 2005, the content of which is hereby incorporated by reference into this application.

### BACKGROUND OF THE INVENTION

This invention relates to a technology of using pieces of information from many sensors connected to a network, and more particularly to a sensor network system used for collecting pieces of information from many regionally distributed sensors to assist decision making as to understanding of a current situation, discovery of abnormality, prediction, and optimization.

There has recently made a progress in development of a sensor network technology of obtaining sensing data from many sensor nodes through a network. The sensor network technology enables use of information obtained by a sensor at a remote place through the network, and must deal with wide and diverse environment observations. In the case of making wide and diverse observations, a variety of many sensor nodes are necessary. When events observed by all those sensor nodes (notifications of measuring results) are directly received by a server, load concentration occurs in the server. To avoid such load concentration, information on events distributed to the servers must be aggregated and filtered to reduce the number of events. Therefore, there has been known a method of installing event handlers in the sensor nodes and the servers and causing these handlers to aggregate and filter the events in a coordinated manner (Nonpatent Documents 1 to 3: [Nonpatent Document 1] Samuel Madden, Michael Franklin, Joseph Hellerstein, and Wei Hong. TinyDB: An Acquisitional Query Processing System for Sensor Networks. ACM TODS(2005), “PDF”, searched on the Internet on May 12, 2005. <URL: http://astragalus.lcs.mit.edu/madden/html/tinydb_tods_final.pdf>, [Nonpatent Document 2] Philip Levis and David Culler, “Mate: A Tiny Virtual Machine for Sensor Networks”, Computer Science Division, University of California, Berkeley, Calif., Intel Research: Berkeley, Intel Corporation, Berkeley, Calif., “PDF”, searched on the Internet on May 12, 2005. <http://www.cs.berkeley.edu/˜pal/pubs/mate.pdf>, [Nonpatent Document 3] A. Boulis, C. C. Han, and M. B. Srivastava, “Design and Implementation of a Framework for Efficient and Programmable Sensor Networks”, “PDF”, searched on the Internet on May 12, 2005. <http://www.ee.ucla.edu/˜boulis/phd/SensorWare-Mobisys03.pdf>).

According to the sensor network, generally, information transmitted from the sensor node and distributed to each system is called an event, and a mechanism of processing the event is called an event handler. A sensor network processing system is anchored by the sensor nodes for distributing environment observation information to the server, a Web Service, a client, each of which executes processing based on the preset rules. For example, Nonpatent Document 1 discloses an event handler which detects an environmental change to execute predetermined processing. The event handler for a preset sensor node is configured by using a script language which is an extension of a structured query language (SQL).

Nonpatent Documents 2 and 3 disclose technologies of controlling sensor nodes based on script languages.

### SUMMARY OF THE INVENTION

The event handler in the above-described conventional example is a program mounted on each node, a sensor node or a server. An operation flow of the event handler is decided before running, and unchangeable during the running. To change the operation flow of the event handler, the program mounted on the node must be re-registered. A size of the program on the node is enormous, so transmission may be impossible through radio communication. For this reason, to change the operation flow, the node must be retrieved to replace the program through wired communication.

Here, a user of the sensor network can process the pieces of information collected from the sensor nodes into various pieces of information to be suitable for use. In this case, a user request can be met by changing an operation flow of each node. However, the changing of the operation flow of each node necessitates re-registration of programs of many nodes as in the case of the conventional example, causing a problem in that it is not easy to change the operation flow.

The following factors are conceivable which necessitate changing of the operation flow.

A first factor is a change in user object. In the case of, a large sensor network usable for a plurality of objects rather than a small sensor network which presumes a specific object but, generally, a plurality of operation flows are decided to realize a plurality of user objects after the start of running the sensor network. Also, the operation flow dynamically changes in assistance with a change in a user object. According to the above-described conventional example, it is difficult for a sensor network manager to change the operation flow so as to correspond to all the changes in the user objects.

A second factor is a change in situation. For example, in a sensor network which monitors a mobile object, it is useless to use a sensor node for observation in which no mobile object exists. In a sensor network which starts an air conditioner based on an observation of a temperature sensor node, it is useless for the temperature sensor node to make observations when fire occurs. In the case of the fixed event handler of the above-described conventional example, it has been difficult to change the operation flow according to such a change in situation.

This invention has been made in view of the aforementioned problems, and it is therefore an object of this invention to provide a sensor network which can dynamically change an operation flow of each node with ease according to a user request or to a user situation.

According to this invention, a data processing method of a sensor network which sequentially transmits pieces of information observed by a sensor node as events to an upper client node from an intermediate node, includes: a step of causing the client node or an upper node of the intermediate node to extract a script for a lower node from scripts having processing preset for a plurality of nodes to distribute the script extracted to the lower node; a step of executing processing for a self node from the script; a step of causing the lower node to receive the script distributed to execute processing for the lower node; and a step of causing the lower node to extract a script for a node lower than the self node from the scripts to distribute the script extracted to the lower node when the script for the lower node is present. Based on a script executed by each node, an event from a lowest sensor node is sent through an upper intermediate node (i.e., a router node, a server) to the client node.

This invention enables control of the operation flow of handling the events distributed to the nodes by one script. Accordingly, as dynamic changes can be made corresponding to user objects which are present by a plurality, cannot be generalized but dynamically changed, diverse user objects can be reflected on a single sensor network. Thus, installation/maintenance costs can be shared among a plurality of users, so it is possible to realize a large sensor network infrastructure for making observations over wide regions.

Further, this invention enables dynamic changing of the operation flow of distributed event handling corresponding to a dynamically changed situation. Thus, as compared with the case of executing the prefixed event handling, it is not necessary to execute useless processing, and therefore the number of events to be distributed can be reduced. Accordingly, it is possible to reduce load concentration in the server. As processing of each node can be stopped when necessary, it is possible to reduce power consumption of each node.

### BRIEF DESCRIPTION OF THE DRAWINGS

FIG. 1 is a block diagram of a sensor network according to a first embodiment of this invention.

FIG. 2 is a block diagram of a main function of each node of the sensor network of this invention to realize distributed event handling according to the first embodiment.

FIG. 3 is an explanatory diagram showing an example of communication between nodes.

FIG. 4 is a device configuration diagram of a sensor node according to the first embodiment.

FIG. 5 is a device configuration diagram of a router node according to the first embodiment.

FIG. 6 is a device configuration diagram of a server according to the first embodiment.

FIG. 7 is a device configuration diagram of a client according to the first embodiment.

FIG. 8 is a block diagram of a connection interface between a script manager and an upper application according to the first embodiment.

FIG. 9 is an internal structure diagram of the script manager according to the first embodiment.

FIG. 10 is an explanatory diagram of a tag tree structure according to the first embodiment.

FIG. 11 is an explanatory diagram of a basic execution sequence of scripts according to the first embodiment.

FIG. 12 is an explanatory diagram of an execution sequence of scripts including asynchronous commands according to the first embodiment.

FIG. 13 is an explanatory diagram of an execution sequence of scripts including parallel commands according to the first embodiment.

FIG. 14 is a processing flowchart (PAD diagram) illustrating an algorithm of a postaction interface according to the first embodiment.

FIG. 15 is a processing flowchart (PAD diagram) illustrating an algorithm of a postCommand interface according to the first embodiment.

FIG. 16 is a PAD diagram illustrating an algorithm of a pareseCommand interface according to the first embodiment.

FIG. 17 is a processing flowchart (PAD diagram) illustrating an algorithm of an onEvent interface according to the first embodiment.

FIG. 18A is a sequential diagram illustrating an operation flow of an event standby command according to the first embodiment. FIG. 18B is an explanatory diagram of scripts. FIG. 18C is an explanatory diagram of an execution sequence of scripts.

FIG. 19A is a sequential diagram illustrating an operation flow of an event standby command according to the first embodiment. FIG. 19B is an explanatory diagram of scripts. FIG. 19C is an explanatory diagram of an execution sequence of scripts.

FIG. 20A is a sequential diagram illustrating an operation flow when the event standby command and the communication command are combined together according to the first embodiment. FIG. 20B is an explanatory diagram of scripts. FIG. 20C is an explanatory diagram of an execution sequence of scripts.

FIG. 21 is an explanatory diagram of scripts illustrating operations of parallel or any commands according to the first embodiment.

FIG. 22 is an explanatory diagram of a compressed script structure according to the first embodiment.

FIG. 23 is a flowchart (PAD diagram) illustrating an algorithm of a postCommand interface for a compressed script according to the first embodiment.

FIG. 24 is a flowchart (PAD diagram) illustrating an algorithm of a parseCommand interface for the compressed script according to the first embodiment.

FIG. 25 is a system configuration diagram illustrating a secondary event identifier problem according to a second embodiment of this invention.

FIG. 26 is a system configuration diagram illustrating a rule number explosion problem according to a third embodiment of this invention.

FIG. 27 is an explanatory diagram of logic description illustrating the rule explosion problem according to the third embodiment.

FIG. 28 is a system configuration diagram illustrating an Ad-Hoc problem according to a fourth embodiment of this invention.

FIG. 29 is an explanatory diagram of a script changing example according to the fourth embodiment.

FIG. 30 is an explanatory diagram of scripts on a sensor node according to a fifth embodiment of this invention.

FIG. 31 is a configuration diagram of a main section of a sensor node using hardware interruption according to a sixth embodiment of this invention.

FIG. 32 is a configuration diagram of a sensor network usable for both normal and emergency times according to a seventh embodiment of this invention.

FIG. 33 is a diagram illustrating an Ad-Hoc sensor network according to an eighth embodiment of this invention.

FIG. 34 is an explanatory diagram of a script using a reflexive structure according to the eighth embodiment.

FIG. 35 is an explanatory diagram of a user interface of a name tag node according to a ninth embodiment of this invention.

FIG. 36 is a configuration diagram of a sensor network according to a tenth or eleventh embodiment of this invention.

FIG. 37 is a diagram showing a user interface for generating scripts according to a twelfth embodiment of this invention.

FIG. 38 is an explanatory diagram of an example of converting a declarative language script of a user request into a procedural language script describing an actual operation according to the twelfth embodiment of this invention.

FIG. 39 is an explanatory diagram of an example of a project management system according to a thirteenth embodiment of this invention.

### DETAILED DESCRIPTION OF THE INVENTION

Hereinafter, an embodiment of this invention will be described with reference to the accompanying drawings.

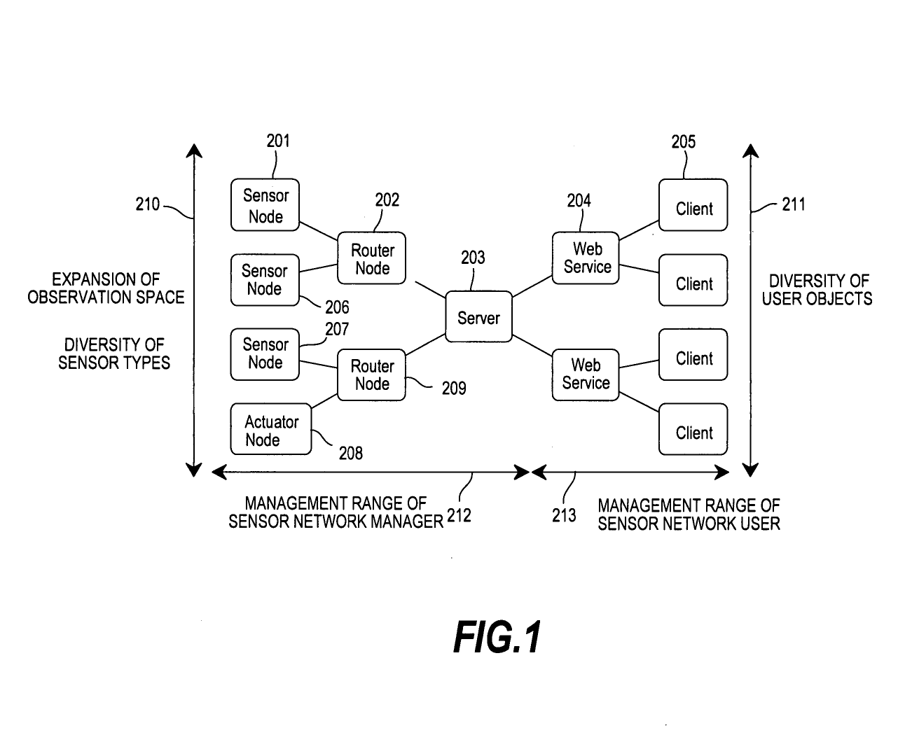

FIG. 1 is a block diagram showing an example of a sensor network to which this invention is applied.

The sensor network is a system for assisting human decision making by observing environmental information at many sensor nodes 201, 206 and 207 distributed in environment, integrating/distributing the observed information via a router node 202 connected through radio or wire communication, and collecting the observed information at a center server 203. The observed information collected by the server 203 is distributed to a plurality of Web services (WEB servers) 204 present according to user objects, and lastly distributed to a client 205 which is a user terminal. Many actuators 208 distributed in environment as in the case of the sensor nodes 202 may control the environment. According to this invention, the sensor node 201, the router node 202, the server 203, the Web Service 204, the client 205, and the actuator node 208 that constitute the sensor network are generally called “nodes”.

The sensor nodes 201, 206 and 207 include sensors such as temperature and humidity sensors, and identifiers for identifying individuals, and are connected to the router nodes 202 and 209. A plurality of sensor nodes 201 and 206 are connected to the router node 202, and pieces of observed information are collected from these sensor nodes. The router node 202 sends pieces of observed information collected from the sensor nodes 201 and 206 therebelow to the server 203. The sensor node 207 and the actuator node 208 are connected to the router node 209, pieces of observed information collected from the sensor node 207 are sent to the server 203, and the actuator node 208 is controlled based on a command from the server 203. The actuator node 208 operates based on conditions set by a user of the client 205 or the like, and includes, e.g., an air conditioner.

The server 203 collects the pieces of observed information sent from the router nodes 202 and 209, and transmits the pieces of observed information or notifications based on the observed information to the client 205 via the plurality of WEB services 204.

In a main application of the sensor network, it is important to know timing of an environmental change. Thus, the processing system of the sensor network employs a system that the sensor node 201 mainly distributes environment observation information to the server 203, the WEB services 204 and the client 205, and each executes processing based on preset rules. Generally, information transmitted from the sensor node 201 and distributed to each system is called an event, and a structure of processing the event is called an event handler.

The processing of the event handler includes three stages of receiving an event, determining conditions, and executes corresponding action. This is generally called an Event-Condition-Action (ECA) model. Generally, the action is a concept to be compared with the event, and it is a processing request provided to the node. Types of actions include issuance of a new event, control of the actuator node 208, and the like.

According to the embodiment, the sensor node 201 side is set as a lower node, and the client 205 is set as an upper node. For example, the sensor node 201 notifies an event or a result based on observed information to a router node 202 as an upper node to which it belongs. The router node 202 notifies the event to the server 203 as an upper node to which it belongs. The server 203 notifies the event to the client 205 as an upper node via a web service.

The router node 202, the server (server node) 203, and the web service (web server node) 204 present between the lower sensor node 201 and the upper client node 205 relay communication between the sensor node 201 and the client 205 as intermediate nodes, and execute scripts from the client 205.

<Configuration of Node and Script of Sensor Network>

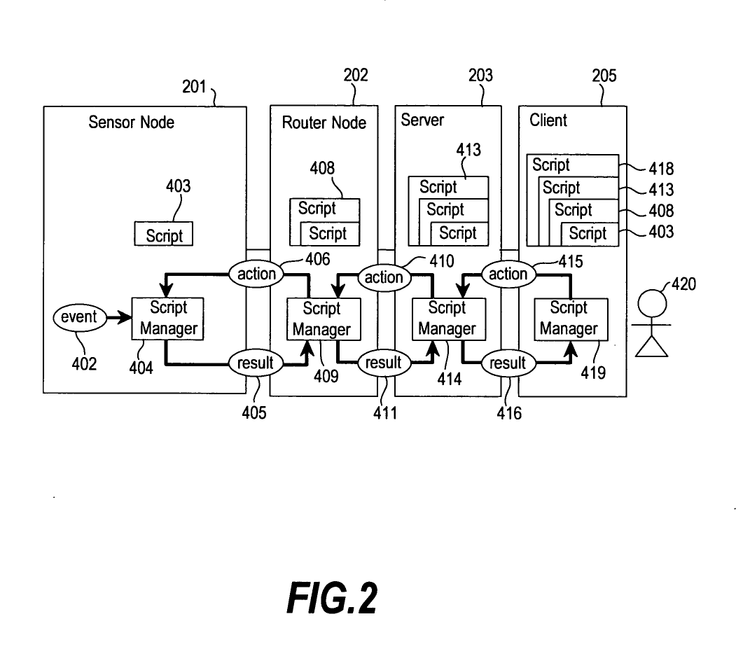

FIG. 2 is a block diagram of a functional element which carries out distributed event handling in the sensor network. In this case, the distributed event handling means execution of notification of events between the nodes on the sensor network by each node in a dispersed manner. In other words, a node that notifies a generation of an event directly notifies the event to a node of a next stage.

Referring to FIG. 2, in those of the sensor node 201, the router node 202, the server 203, and the client 205 that wish to carry out event handling, script managers 404, 409, 414, and 419 which are script execution engines of this invention are installed in place of event handlers to execute distributed event handling. It should be noted that the web service 204 which does not perform event handling is omitted in FIG. 2. The sensor nodes 206 and 207, the actuator node 208, the router node 209, and the other nodes such as the client 205 shown in FIG. 1 can be similarly configured.

A user 420 who wishes to set an operation flow of distributed event handling in the sensor network describes a script 418 which defines the entire operation flow at the client 205, and requests execution to the script manager 419. The script 418 contains partial scripts 413, 408, and 403 which execute event handling in a recursive manner at each node.

In the process of the script execution, the script manager 419 of the client 205 transmits the partial script 413 to the script manager 414 of the other node (server 203) 412, and executes an action 415 to request script execution. By repeating this in a recursive manner, the scripts 403, 408, 413, and 418 can be distributed to all the nodes 201, 202, 203, and 205.

In other words, in the script 418, scripts of other nodes are arranged in a nested structure in sequence according to the stages of the sensor network. The script 418 executed at the client 205 contains the script 413 executed at the server 203. This script 413 contains the script 408 executed at the router node 202. The script 408 contains the script 403 executed at the sensor node 201.

When the script manager 419 of the client 205 executes the script 418, the script 413 is extracted to be transmitted to the server 203 as described above. At the server 203, when the script manager 414 executes the received script 413, the contained script 408 is extracted to be transmitted to the router node 202. At the router node 202, when the script manager 409 executes the script 408 received from the server 203, the contained script 403 is extracted to be transmitted to the sensor node 201. At the sensor node 201, the script manager 404 executes the script 403.

Thus, the nested scripts defined at the client 205 can be sequentially extracted at the respective nodes to be transmitted, and executed by the script managers of the nodes. By defining one script, the plurality of nodes can be controlled. The example of distributing the partial scripts 408 and 403 to one sensor node 201 and one router node 202 to execute has been described. However, by containing scripts for a plurality of sensor nodes 201 or a plurality of router nodes 202 in one script, it is possible to control many nodes by one script.

An observation event 402 of the sensor node 201 is determined by the script manager 404 of the sensor node 201 according to rules of the script 403, and distributed as a command execution completion event 405 of the script 403 to the router node 202.

Sequentially thereafter, events are transmitted as command execution completion events 411 and 416 to the upper nodes, e.g., from the router node 202 to the server 203, and from the server 203 to the client 205.

<Configuration of Script>

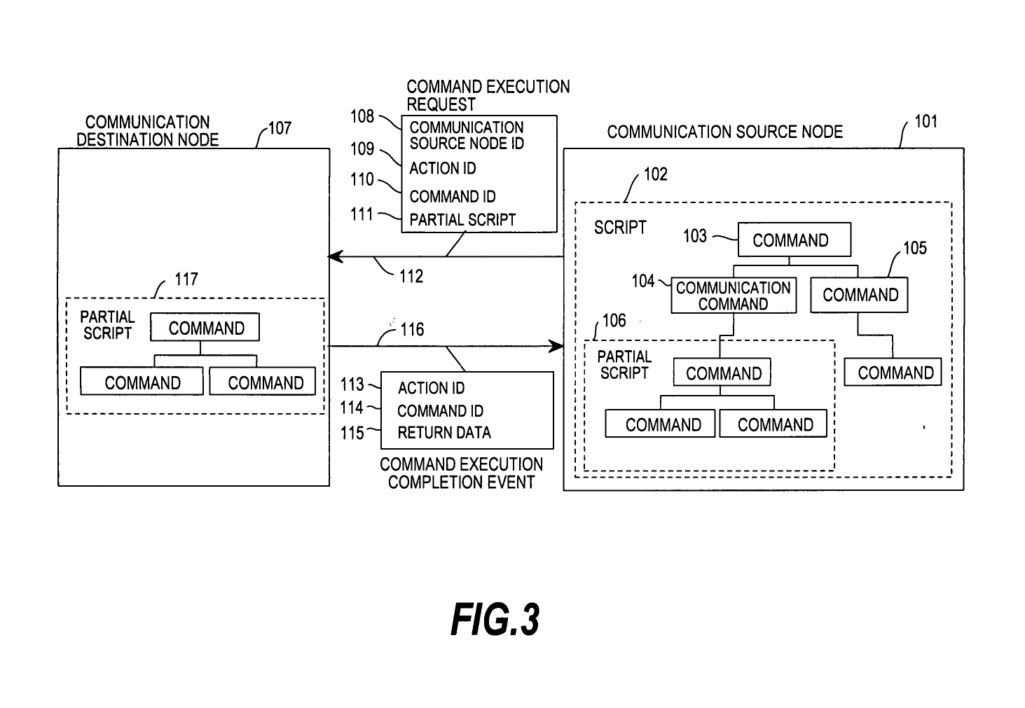

FIG. 3 is an explanatory diagram of processing executed between the nodes of FIG. 2. Referring to FIG. 3, a relation between a script 102 of a communication source node 101 and a script 117 of a communication destination node 107 is shown. For example, the script 102 corresponds to the script 418 of the client 205 of FIG. 2, and the script 117 corresponds to the script 413 of the server 403.

The script manager that is the script execution engine of this invention receives the script 102 represented in a command tree structure, a representation method similar to a functional language such as lisp, and executes the script by an interpreter system.

As in the case of the functional language, a basic command execution sequence rule has a processing system of executing all child commands (104 and 105) in an appearance sequence thereof before execution of a parent command 103 of the communication source node 101, and setting command return data as an argument for the parent command 103.

Further, as a new command execution sequence rule of this invention, asynchronous commands are introduced. During asynchronous command execution, an asynchronous command processing main body uses a function of transmitting, as a command execution request 112, (1) an action ID 109 for uniquely identifying a script being executed, (2) a command ID for uniquely identifying the asynchronous command in the script, and (3) a partial script 106 in which the asynchronous command is a root as a partial script 111 to the communication destination node 107, requesting execution of the partial script 111 at the communication destination node 107, and saving the script 102 at the communication source node 101 to temporarily stop the script, and a function of receiving, as a command execution completion event 116, the action ID 113 and the command ID 114 together with return data 115 at the communication source node 101, and resuming execution from a command position identified by the command ID 115 based on the execution sequence rule. Thus, asynchronous processing is enabled.

An event handler that waits for a specific event is mounted as an asynchronous command processing main body accessed from the asynchronous command, event distribution reservation is made to an event publisher configured by mounting a Publish/Subscribe model (Pub/Sub model) present at each node during asynchronous command execution, and the asynchronous command is returned at a point of time when the event is distributed. Thus, “event handling by script” can be realized.

A communication function to the communication destination node 107 is mounted as an asynchronous command processing main body accessed from the asynchronous command, and in addition to the action ID 109, and the command ID's 110 and 111 which are transmission contents to the asynchronous command processing main body, a communication source node ID 108 is added as communication contents to the communication destination node 107, whereby a function of causing the communication source node 101 to request script execution to the communication destination node 107 can be realized. By transmitting the “event handler by script” as the partial script 106 communicated to the communication destination node, it is possible to distribute event handlers from a single script to a plurality of nodes.

The event handlers can be distributed/registered in the plurality of nodes by the script input from the user. Accordingly, it is possible to dynamically change the operation flow of the sensor network according to a change in user object. Moreover, the script manager of each node can distribute the event handler according to the script. Accordingly, for example, as a result of condition determination of a certain event, the operation flow of the sensor network can be dynamically changed according to a situation to distribute/register a new event handler.

It is to be noted that the node ID 108 communicated between the nodes is decided as a unique identifier on the sensor network by the server 203 which controls the entire sensor network to be managed.

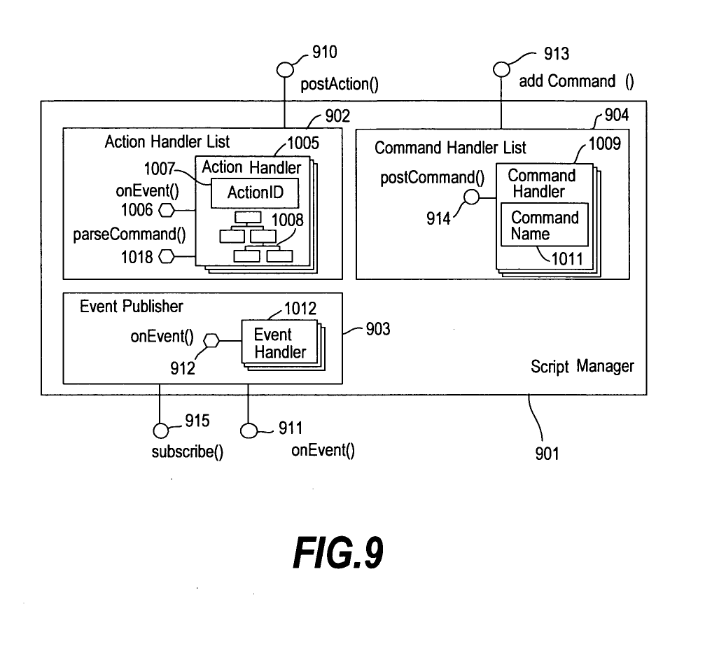

The action ID's 109 and 113 are provided as unique identifiers in an action handler list by an action handler list 902 of the script manager (described later). The command ID's 110 and 114 are provided by the action handler list 1005 (shown in FIG. 9) of the script manager by the timing of requesting script processing.

<Details of Components of Sensor Network>

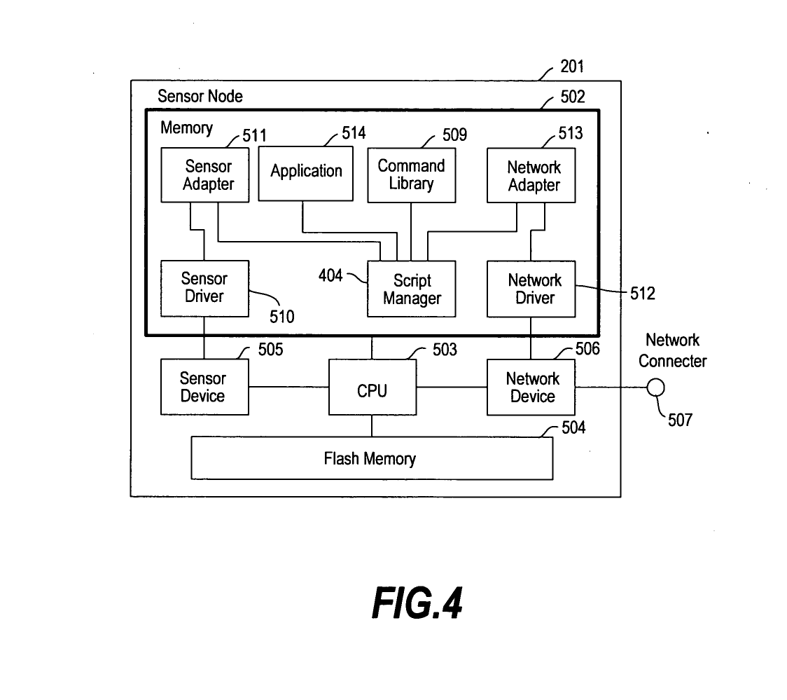

Next, referring to FIGS. 4 to 7, details of the components of the sensor network shown in FIG. 2 will be described.

<Details of Sensor Node>

FIG. 4 is a block diagram showing a device configuration of the sensor node 201. Though not shown, the sensor nodes 206 and 207 shown in FIG. 1 are similarly configured.

The sensor node 201 observes an environment to issue an event, and includes a memory 502, a CPU 503, a flash memory 504 for executing long-time data recording, a sensor device 505 for observing an environment, a network device 605 for executing communication, and a network connector 507. At the time of starting the sensor node 201, programs (404, and 509 to 513) recorded in the flash memory 504 are read on the memory 502, and executed by the CPU 503 to be processed.

The program read on the memory 502 includes a script manager 404 which is a script execution engine of this invention, a command library 509 which is a set of processing main bodies of commands constituting the script, a sensor driver 510 for making observations by using the sensor device 505, a sensor adaptor 511 for connecting the sensor driver 510 to the script manager 404, a network driver 512 for executing communication by using the network device 605 and the network connector 507, a network adapter 513 for connecting the network driver 512 to the script manager 404, and an application 514 properly installed according to a user object.

Any types of a network device 605 and a network connector 507 may be used as long as they enable bidirectional communication with another node having a specific identifier. Examples are those in which a wire communication standard Ethernet (registered trademark), a radio communication standard Blue Tooth, IEEE802.15.4, ZigBee, and the like are mounted.

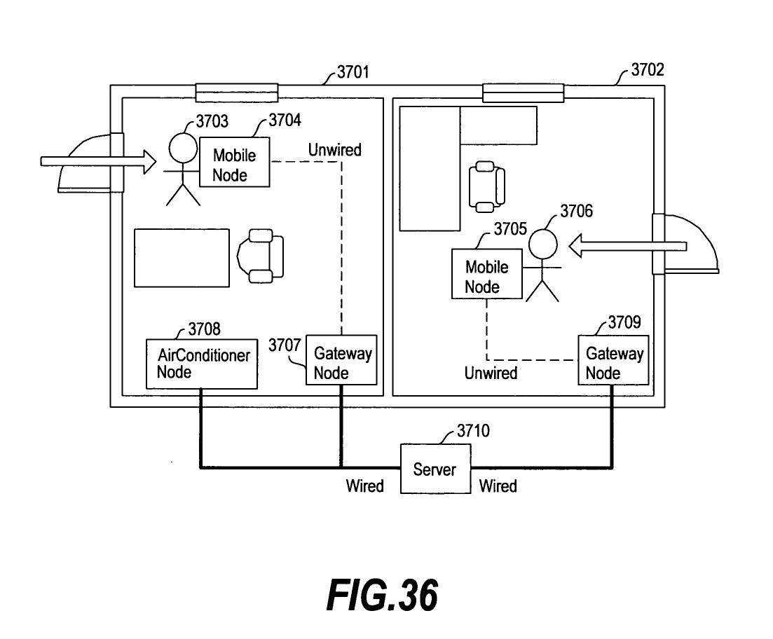

For the sensor device 505, for example, a temperature sensor, a humidity senor, an illuminance sensor, a distortion sensor for detecting bolt loosening, a pressure sensor for detecting sitting on a chair or opening/closing of a door, an infrared sensor for detecting a presence of a human, an infrared sensor for detecting pulsation, or the like can be cited. A name tag node shown in FIG. 36 is a type of a sensor node 201, and a switch for detecting user's button inputs 3603, 3604, and 3605 becomes a sensor device 505.

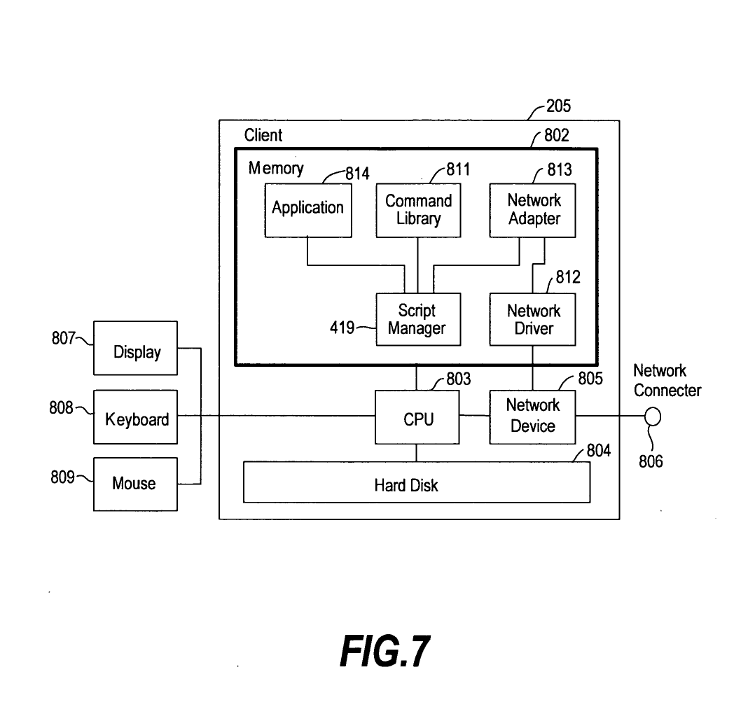

The client 205 shown in FIG. 7 is also a type of a sensor node 201. A keyboard 808 or a mouse 809 becomes a sensor device 505. It is possible to observe information as to attendance checking based on whether the user currently executes an operation, or a type of work by detecting a currently operated application name.

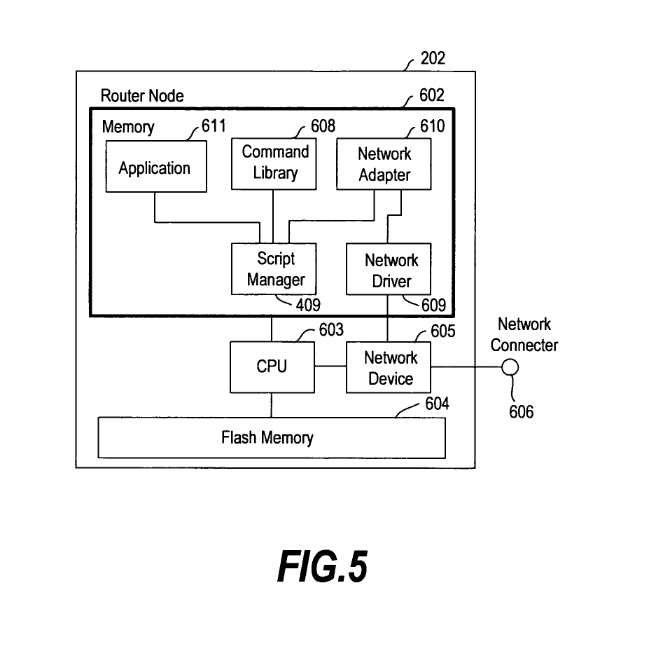

A device configuration of the actuator node 208 shown in FIG. 1 is similar to that of the sensor node 201 shown in FIG. 5 except for replacement of the sensor adapter 511, the sensor driver 510, and the sensor device 505 respectively by an actuator adapter, an actuator driver, and an actuator device, and thus description thereof will be omitted. Examples of the actuator device are an air conditioner, an alarm, a speaker, a light equipped with a dimmer function, and the like.

As a node that combines the sensor node and the actuator node together, an automatic moving type robot can be cited. Examples are a robot which moves toward an observation target, a cleaner robot which moves based on observed information, and the like. By using this invention, its behavior can be freely changed based on a script from the server 203. Additionally, even when the connection with the router node is temporarily cut off by the automatic movement, an operation is determined at the script manager 404 based on an input from the sensor device 505, whereby a movement can be made by using the actuator device.

<Details of Router Node>

FIG. 5 is a block diagram showing a device configuration of the router node 202. It is to be noted that the router node shown in FIG. 1 is similarly configured.

The router node 202 relays communication, and includes a memory 602, a CPU 603, a flash memory 604 for executing long-time data recording, a network device 605 for executing communication, and a network connector 607. At the time of starting the router node 601, programs (409, and 608 to 610) recorded in the flash memory 604 are read on the memory 602, and executed by the CPU 603 to be processed.

The program read on the memory includes a script manager 409 which is a script execution engine of this invention, a command library 608 which is a set of processing main bodies of commands constituting the script, a network driver 609 for executing communication by using the network device 605, a network adapter 610 for connecting the network driver 609 to the script manager 409, and an application 611 properly installed according to a user object.

A gateway node for connecting radio communication and wire communication is also a type of a router node. In this case, for each of a network adaptor 610, a network driver 609, a network device 605, and a network connector 606, two sets are provided for radio communication and wire communication. The router node 202 that executes radio communication can be regarded as the sensor node 201 for detecting events of “connected to new node”, and “connected node is broken away”. For example, as in the case of a name tag node 3601 shown in FIG. 36, there is no guarantee that a sensor node carried by a human is always connected to a fixed router node. By using this nature, the router node connected to the name tag node can observe an event of “human carrying name tag node arrives”, and the router node that checks the breakaway of the name tag node can observe an event of “human carrying name tag node leaves”.

<Details of Server Node>

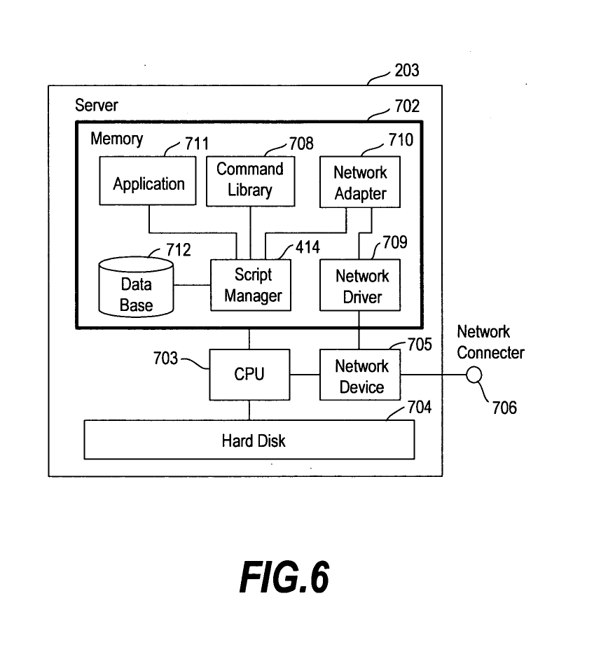

FIG. 6 is a block diagram showing a device configuration of the server 203.

Referring to FIG. 6, the server 203 is a node for collecting/accumulating/distributing pieces of observed information, and includes a memory 702, a CPU 703, a hard disk 704 for executing long-time data recording, a network device 705 for executing communication, and a network connector 706. At the time of starting the server 203, programs (414, and 708 to 712) recorded in the hard disk 704 are read on the memory 702, and executed by the CPU 703 to be processed. In place of the hard disk 704, a storage device of SAN or NAS may be used.

The program read on the memory 702 includes a script manager 414 which is a script execution engine of this invention, a command library 708 which is a set of processing main bodies of commands constituting the script, a network driver 709 for executing communication by using the network device 705, a network adapter 710 for connecting the network driver 709 to the script manager 414, an application 711 properly installed according to a user object, and a data base 712.

In the network adaptor 710, various protocols may be mounted to transfer events to the client 205 by various means. For example, pop-up notification or data transfer may be carried out by Session Initiation Protocol (SIP), mail may be transmitted by Simple Mail Transfer Protocol (SMTP), or an event described in Hyper Text Markup Language) XML or the like may be transmitted by Hyper Text Transfer Protocol (HTTP). The protocols can be used as routes for a script transfer/execution request reversely from the client to the server. A device configuration of the WEB service (web server) 204 is similar to that of the server 203 shown in FIG. 6, and thus description thereof will be omitted.

<Details of Client Server>

FIG. 7 is a block diagram showing a device configuration of the client 205.

The client 205 is a node which serves as an interface with the user to present a request input from the user, a result, or an event, and includes a memory 802, a CPU 803, a hard disk 804 for executing long-time data recording, a network device 805 for executing communication, a network connector 806, a display 807 for presenting the result or the event to the user, and a keyboard 808 and a mouse 809 for receiving the request input from the user. At the time of starting the client 205, programs (419, and 811 to 814) recorded in the hard disk 804 are read on the memory 802, and executed by the CPU 803 to be processed.

The program read on the memory 802 includes a script manager 419 which is a script execution engine of this invention, a command library 811 which is a set of processing main bodies of commands constituting the script, a network driver 812 for executing communication by using the network device 805, a network adapter 813 for connecting the network driver 812 to the script manager 419, and an application 814 properly installed according to a user object.

<Outline of Script Manager>

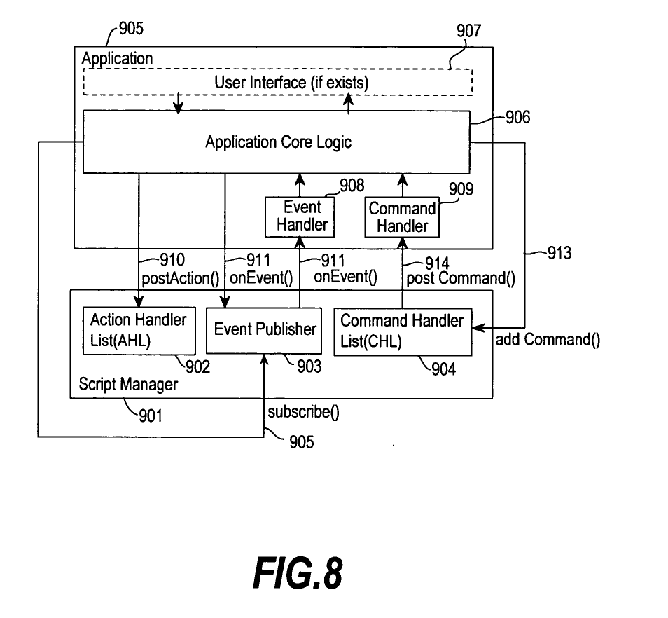

Referring to FIG. 8, a connection interface between the script manager 901 of this invention and the upper application 905 will be described. The script manager 901 of FIG. 8 corresponds to each of the script managers 404, 409, 414, and 419 of FIG. 2. The upper application indicates all programs which use the script manager 901 of this invention. Examples of upper applications are the command library 509, the sensor adapter 511, and the network adapter 513 connected to the script manager 404 of FIG. 2, and the application 711 and the database 712 of FIG. 6.

For convenience, a program block which is a center of the upper application 905 will be called a core logic (Application Core Logic) 906. In the client 205 or the like of FIG. 7, there is a core logic 906 having a user interface 907 for executing interaction with the user.

The script manager 901 includes an action handler list 902 for managing a plurality of scripts being executed, an event publisher 903 configured by mounting the Pub/Sub model, and a command handler list 904 for managing commands to be executed by the script.

A relation between the script manager 901 and the upper application is largely classified into the following twp types:
(1) The upper application requests processing to the script manager 901.
(2) The script manager 901 requests processing to the upper application.

When the upper application requests processing to the script manager 901, a postaction interface 910 and an onEvent interface 912 are used. The upper application uses the script as an argument to access the postaction interface 910, thereby executing the script. An execution result of a synchronous action is returned as this return, and an execution result of asynchronous action is retuned to a pre-registered event handler 908 through the onEvent interface 912.

When the script manager 901 requests processing to the upper application, an addCommand interface 913 and a postCommand interface 914 are used. The addCommand interface 913 registers a new command and a command handler 909 which is a processing main body in the script manager 901. When a command registered in the context of the script appears, the script manager 901 requests processing to the upper application via the postCommand interface 914 of the command handler 909.

The script manager 901 includes an event publisher 903 configured by mounting a Pub/Sub model, and has a function of transmitting an event to the script manager 901 through the onEvent interface 911, and a function of making event distribution reservation to the script through a subscribe interface 915 to distribute the event through the onEvent interface 912.

<Details of Script Manager>

Referring to FIG. 9, an internal structure of the script manager 901 of FIG. 8 will be described.

The script manager 901 has the action handler list 902, the command handler list 904, and the event publisher 903 therein.

The action handler list 902 is a block for managing a plurality of scripts being executed. The action handler list 902 stores 0 or more action handlers 1005. The action handler 1005 manages a script requested to be processed by the upper application in a tag tree 1008 unfolded in a command-unit tree structure. The action handler 1005 has an action ID 1007 which is an identifier for uniquely identifying the action handler in the action handler list 902. The action ID 1007 is provided from the action handler list 902 by the timing of the script processing request.

The command handler list 904 is a block for managing a group of executable commands registered in the script manager 901. The command handler list 904 stores 0 or more command handlers 1009. The command handler 1009 is a processing main body for commands constituting the script. The command handler 1009 has an identifier for uniquely indicating a command name in a command name 1011.

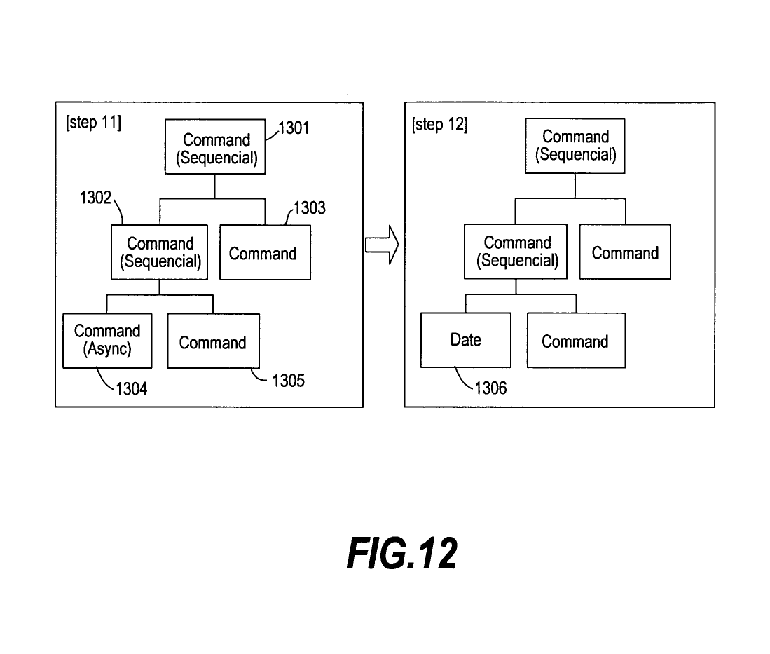

The event publisher 903 stores 0 or more event handlers 1012. The event handler 1012 is a processing main body of response to an event reserved in the event publisher 903. As a special event handler for receiving a command execution completion event of an asynchronous command described later with reference to FIG. 12 of this invention, an event handler 1005 may be stored.

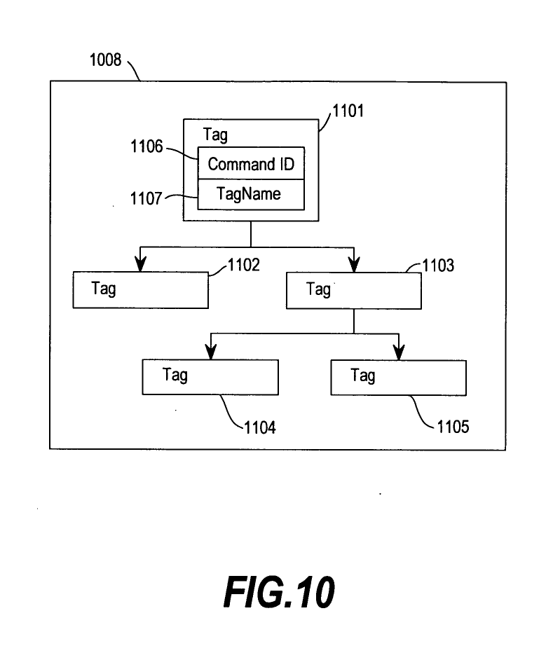

Referring to FIG. 10, a structure of the tag tree 1008 of the action handler 1005 of FIG. 9 will be described.

The tag tree 1008 has a structure similar to a Document Object Model (DOM) which is one of standard models of eXtended Markup Language (XML) proposed by World Wide Web Consortium (W3C).

The tag tree 1008 employs a structure which. has a tag 1101 as a root and 0 or more children in a recursive manner. For example, children of the root tag 1101 are tags 1102 and 1103, and children of the tag 1103 are tags 1104 and 1105.

Each tag has a command ID 1106 which is an identifier for uniquely identifying a tag position in the action handler 1005 of FIG. 9, and a tag name 1107 for indicating a name of a command or data as attributes. The command ID 1106 is provided from the action handler 1005 by the timing of the script processing request.

The postaction interface 910 of the script manager 901 of FIG. 9 is accessed to request script execution. Accordingly, a new action handler 1005 is created in the action handler list 902, and scripts are spread in the tag tree 1008. The action handler 1005 analyzes tags in an execution sequence (described later) from the root tag 1101 (refer to FIG. 10) of the tag tree 1008 shown in FIG. 10, and accesses the postCommand interface 914 of the command handler 904 coincident with the tag name 1107 and the command name 1011 in the command handler list 904 to request command processing.

<Script System>

Next, a language system of the script received by the script manager 901 of this invention will be described. A script representation method of this invention is a recursive hierarchical structure. In description below, a script will be represented by XML. However, as long as they are recursive hierarchical structures, other structures of S type representation such as lisp or scheme, XML subrepresentation such as ConciseXML may be employed.

First, a format of this script is defined by Extended Backus Naur Form: ISO/IEC 14977 (EBNF).
[Formula 1] <Script>::=<CommandLine>
[Formula 2] <CommandLine>::=<Command> <Param>*
[Formula 3] <Param>::=<CommandLine>|<Data>
[Formula 4] <Command>::=<SyncCommand>|<AsyncCommand>
[Formula 5] <Command>::=<SequentialCommand>|<ParallelCommand>

As can be understood, the script <Script> is represented by a structure where a single command <Command> is set as a root, 0 or more commands <Command> or data <Data> are provided as arguments <Param> thereof, and this is repeated in a recursive manner.

The commands are classified into a synchronous command <SyncCommand> and an asynchronous command <AsyncCommand>, or a sequential command <SequentialCommand> and a parallel command <ParallelCommand>.

The classification into the synchronous and asynchronous commands is based on whether processing of the command itself is synchronous processing or asynchronous processing.

The synchronous command is for executing synchronous processing. In other words, control is not returned until command processing is finished. Examples of synchronous commands are four operation commands such as an addition command and a multiplication command.

The asynchronous command is for executing asynchronous processing. In other words, control is returned before command processing is finished. The asynchronous command is used when a command processing time is too long to be ignored or indefinite, or there is a possibility of no return of a command processing result. Examples of asynchronous commands are a command for executing long-time calculation such as statistical processing, a command for making an inquiry to the user to wait for a response input, an event standby command which is an event handler mounted by a script, a communication command, and the like. The return of asynchronous processing from an asynchronous command processing main body arrives as a command execution completion event, and returned to the action handler 1005 via the onEvent interface 1006 of the action handler 1005 of FIG. 9.

The classification into the sequential and parallel commands is based on whether a group of commands positioned in children of the commands is executed in parallel or not.

The sequential command does not perform parallel execution. In other words, in a certain child command of the commands, when the child command itself or its descendent command is an asynchronous command, processing is stopped until a command execution completion event of the asynchronous command arrives.

The parallel command performs parallel execution. In other words, in a certain child command in the commands, when the child command itself or its descendent command is an asynchronous command, a younger brother command of the child command is executed without waiting for the arrival of a command execution completion event of the asynchronous command.

By using the addCommand interface 913 of FIG. 8, the commands can be freely expanded by all or one of a creator of the script manager 901, a manager of the sensor network, and the user.

<Execution Sequence of Scripts>

<1. <Basic Execution Sequence>

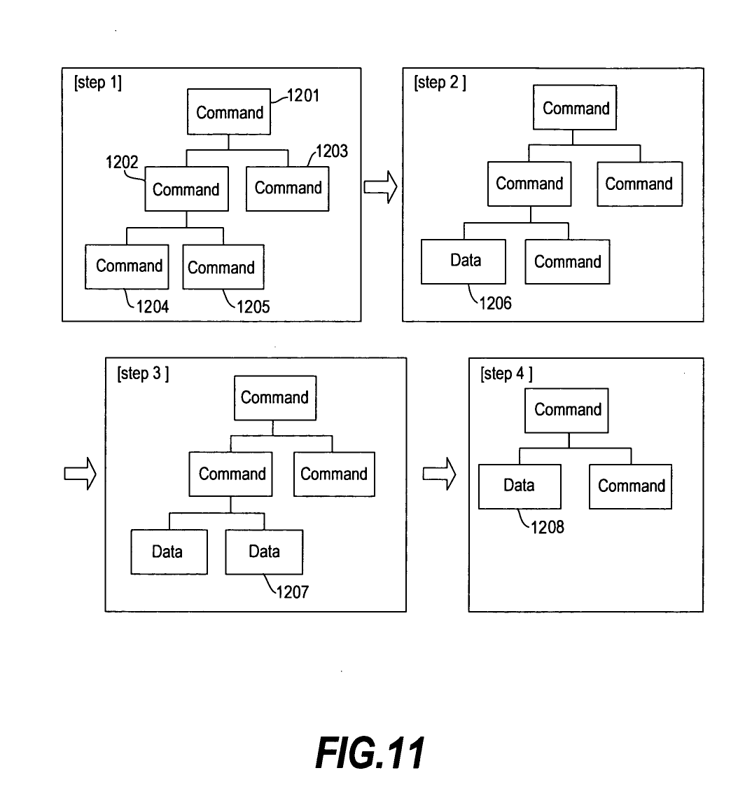

Next, referring to FIGS. 11 to 14, an execution sequence of scripts will be described.

First, by using an example of FIG. 11, an execution sequence of scripts constituted of only synchronous and sequential commands will be described. The execution sequence of the scripts constituted of only the synchronous and sequential commands abides by the following rules as in the case of the functional language.
[rule 1] The script starts execution from a command of a root (parent).
[rule 2] The command executes all child commands, and then executes itself by using a result of the execution as an argument.
[rule 3] The command substitutes itself with data of a result of the execution after its execution.
[rule 4] When the root command is finished, the script is finished.

By abiding these rules, the script of FIG. 11 is executed through the following steps.
[step 1] First, execution of a root command 1201 is tried. As the command 1201 has child commands 1202 and 1203, execution of the command 1202 is tried. As the command 1202 has child commands 1204 and 1205, execution of the command 1204 is tried.
[step 2] The command 1204 is directly executed as it has no children, and substituted with data 1206 which is an execution result. Next, execution of the younger brother command 1205 of the command 1204 is tried. The younger brother command indicates a command relatively low in execution sequence among commands at the same stage. In other words, in FIG. 11, the commands 1202 and 1294 are older brother commands, while the commands 1203 and 1205 are younger brother commands.
[step 3] The command 1205 is directly executed as it has no children, and substituted with data 1207 which is an execution result.
[step 4] As all the child commands of the command 1202 have been executed, the command 1202 itself is executed, and substituted with data 1208 which is an execution result.

By repeating this in a recursive manner, all the commands described in the tree structure can be executed. At a point of time when the root command is substituted with the data, the script is finished to return data which is a result to the user.

By the processing, the script having the commands of the tree structure is executed sequentially from the child command of the tip of the tree structure to the root (parent) command, the execution command of each child command is substituted with the data, and the execution result of the lastly executed root command is sent to the user.

<2. Execution Sequence When Asynchronous Command is Contained>

Next, an execution sequence of a script containing an asynchronous command will be described. The execution sequence of the script containing the asynchronous command abides by the following rules in addition to the [rules 1 to 4].
[rule 5] The asynchronous command is immediately finished in an uncompleted state without waiting for execution completion.
[rule 6] The sequential command finishes itself in an uncompleted state when the child command is finished in an uncompleted state.
[rule 7] When the root command is finished in an uncompleted state, the script is finished in an uncompleted state.
[rule 8] When a command execution completion event is received, processing is resumed from the asynchronous command.
[rule 9] When the script resumed by the command execution completion event is finished, a script execution completion event is sent to the user.

By abiding these rules, the script of FIG. 12 is executed through the following steps. It should be noted that this example includes a sequential command 1301 has a sequential command 1302 as a child, and the sequential command 1302 has an asynchronous command 1304 as a child.

First, in step 11, execution of the root command 1301 is tried. As the root command 1301 has children 1302 and 1303, execution of the child command 1302 is tried. As the command 1302 has children commands 1304 and 1305; execution of the command 1304 is tried. The command 1304 is directly executed as it has no children. As the command 1304 is an asynchronous command, execution is requested to an asynchronous command processing main body, and it is finished in an uncompleted state. The sequential command 1302 finishes itself in an uncompleted state as the child 1304 is uncompleted. The sequential command 1301, which is the root, finishes itself in an uncompleted state as the child 1302 is finished in the uncompleted state. The root command 1301 is finished in the uncompleted state. Accordingly, the script is finished in an uncompleted state, and control is returned to the user.

Next, in step 12, at a point of time when processing of the processing main body of the asynchronous command 1304 is completed, a command execution completion event is issued, whereby the asynchronous command 1304 is substituted with data 1306 which is a command execution result. The sequential command 1302 tries execution of a command 1305 which is a younger brother of the asynchronous command 1304. After completion of all children of the sequential command 1302, the command 1302 is executed. Upon execution completion of the child 1302, the sequential command 1301 tries execution of a younger brother command 1303 of the child 1302. After completion of all the children of the root command 1301, a script execution completion event is sent to the user.

By the processing, when the script of the tree structure contains an asynchronous command, the asynchronous command requests execution to the asynchronous command processing main body to be finished in an uncompleted state. Then, when a command execution completion event is issued at a point of time when the processing of the asynchronous command processing main body is completed, the other child commands finished in uncompleted states are sequentially executed.

<3. Execution Sequence When Parallel Command is Contained>

Next, an execution sequence of the script containing a parallel command will be described. The execution sequence of the script containing the parallel command abides by the following rules in addition to the [rules 1 to 9].
[rule 10] The parallel command tries execution of all the child commands irrespective of any end states, i.e., completed or uncompleted state, of a specific child command.
[rule 11] The parallel command finishes itself in an uncompleted state when there is a child command of an uncompleted state at a stage where all the child commands have been executed.

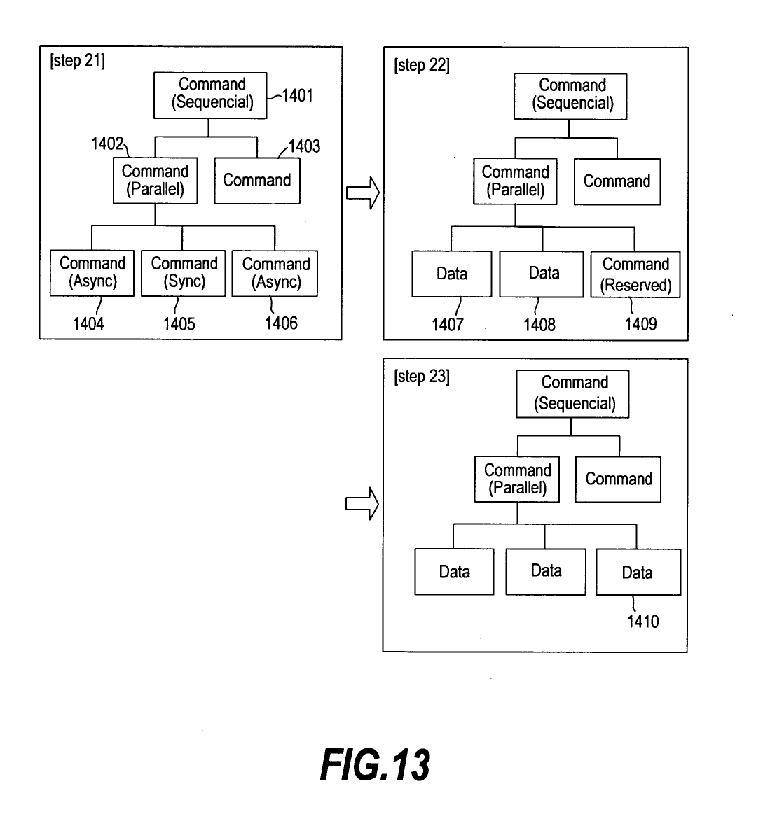

By abiding these rules, the script of FIG. 13 is executed through the following steps. It should be noted that in this example, a sequential command 1401 has a parallel command 1402 as a child, and the parallel command 1402 has asynchronous commands 1404 and 1406, and a synchronous command 1405 as children.

First, in step 21, execution of the root command 1401 is tried. As the root command 1401 has children 1402 and 1403, execution of the command 1402 is tried. As the command 1402 has children 1404, 1405, and 1406, execution of the command 1404 is tried. The command 1404 is directly executed as it has no children. As the command 1404 is an asynchronous command, execution is requested to an asynchronous command processing main body, and it is finished in an uncompleted state. The parallel command 1402 tries execution of the younger brother 1405 of the asynchronous command 1404. As the command 1405 is a synchronous command, its execution is immediately completed to substitute the command with data 1408. The parallel command 1402 tries execution of the younger brother command 1406 of the synchronous command 1405. As the command 1406 is an asynchronous command, execution is requested to the asynchronous command processing main body to finish the command in an uncompleted state. The parallel command 1402 that has executed all the children finishes itself in an uncompleted state as the children 1404 and 1406 are uncompleted. The sequential command 1401 finishes itself in an uncompleted state as the child 1402 is finished in the uncompleted state. The root command 1401 is finished in the uncompleted state. Accordingly, the script is finished in an uncompleted state, and control is returned to the user.

In step 22, at a point of time when processing of the processing main body of the asynchronous command 1404 is completed, a command execution completion event is issued, whereby the asynchronous command 1404 is substituted with data 1407 which is a command execution result. The parallel command 1402 checks completion of processing of all the children, and finishes itself in an uncompleted state as the child 1409 is uncompleted. The sequential command 1401 finishes itself in an uncompleted state as the child 1402 has been finished in the uncompleted state. Since the root command 1401 has been finished in the uncompleted state, the script is finished in an uncompleted state.

Next, in step 23, at a point of time when processing of the processing main body of the asynchronous command 1406 is completed, a command execution completion event is issued, whereby the asynchronous command 1406 is substituted with data 1410 which is a command execution result. The parallel command 1402 checks completion of processing of all the children, and executes itself as execution of all the children has been completed. Upon execution completion of the child 1402, the sequential command 1401 tries execution of a younger brother command 1403 of the child 1402. After completion of all the children of the root command 1401, a script execution completion event is sent to the user.

By the processing, when there is a parallel command, the parallel command executes child commands in parallel. Then, when a child command or its descendent command is an asynchronous command, a younger brother command of the child command is executed without waiting for the arrival of a command execution completion event of the asynchronous command.

<Execution Algorithm of Script>

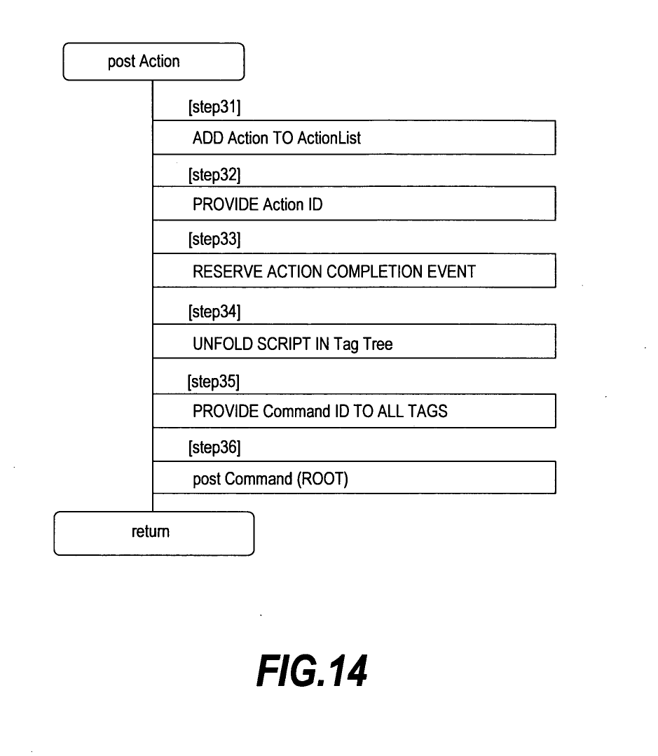

Next, referring to FIGS. 14 to 17, an execution algorithm of the script will be described.

<Basic Processing>

Referring to FIG. 14, description will be made of a basic processing flow when the postaction interface 910 of FIGS. 8 and 9 is executed, i.e., the upper application inputs a script indicating an action to the script manager 901, and requests execution of the action.
[step 31] A new action handler 1005 is created for the script input by the upper application to be added to the action handler list 902.
[step 32] The action handler list 902 creates a new identifier unique in the action handler list, and stores it in the action ID 1007 which is an action attribute.
[step 33] The action handler 1005 registers itself as an event handler in the event publisher 903.
[step 34] The action handler 1005 unfolds the script in the tag tree 1008, and stores a tag name described in the script in the attribute tag name 1107 of each node of FIG. 10.
[step 35] The action handler 1005 traces all the nodes of the tag tree 1008 in a recursive manner, thereby storing the identifier unique in the action handler 1005 in the command ID 1106.
[step 36] The action handler 1005 executes a command designated by the root 1101 of the tag tree 1008. In other words, a command of a name designated by the attribute tag name 1107 of the root command 1101 shown in FIG. 10 is searched for in the command handler list 904. When a command handler 1009 having a command name 1011 similar to the tag name 1107 is discovered, the postCommand interface 1010 of the command handler 1009 is accessed.

<postCommand Interface>

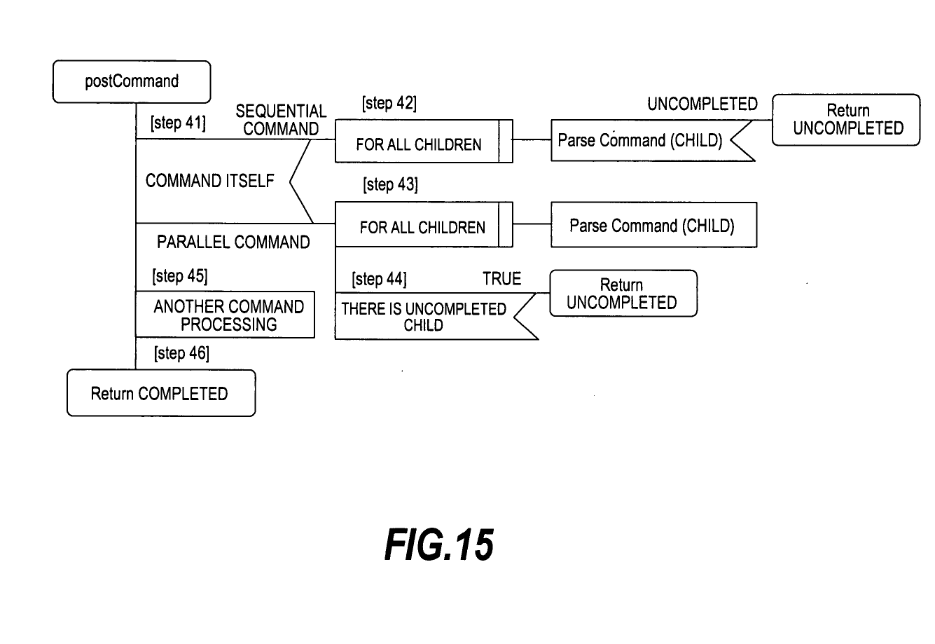

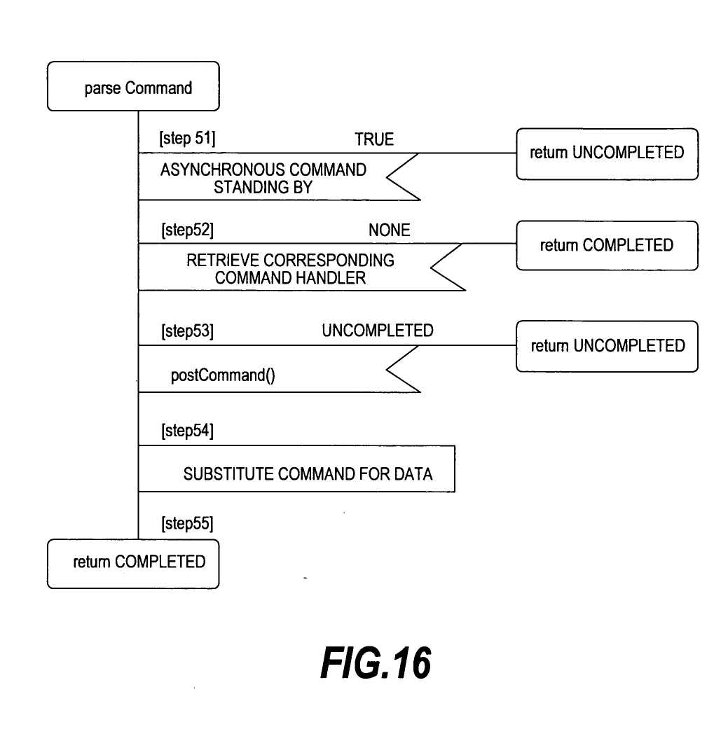

Referring to FIG. 15, an algorithm of the postCommand interface 914 of the command handler 1009 of FIG. 9 accessed in the step 36 of FIG. 14 will be described.
[step 41] Determination is made as to whether a currently processed command (itself) is a sequential command or a parallel command.
[step 42] In the case of the sequential command, a parseCommand interface described later with reference to FIG. 16 is accessed for all the child commands. When a return is “uncompleted”, the processing is immediately stopped to end in an uncompleted state.
[step 43] In the case of the parallel command, the parseCommand interface is accessed for all the children.
[step 44] After the end of execution for all the children, when there is even one child command whose return is “uncompleted”, the processing is finished in an uncompleted state.
[step 45] Each command processing is executed for itself.
[step 46] The processing is finished in a “completed state”.

<parseCommand Interface>

Referring to FIG. 16, an algorithm of the parseCommand interface 1018 of the action handler 1005 accessed in the steps 42 and 43 of FIG. 15 will be described.
[step 51] When a currently processed command is an asynchronous command, and a command execution completion event has not arrived, the processing is finished in an uncompleted state.
[step 52] A command handler 1009 of a corresponding command is searched for in the command handler list 904. When there is no proper handler, as the tag is not a command but data, the processing is finished in a completed state.
[step 53] The postCommand interface 914 of the relevant command handler 1009 is accessed. When a return is “uncompleted”, the processing is immediately stopped to be finished in an uncompleted state.
[step 54] The command is substituted with data which is its return result.
[step 55] The processing is finished in a “completed state”.

<onEvent Interface>

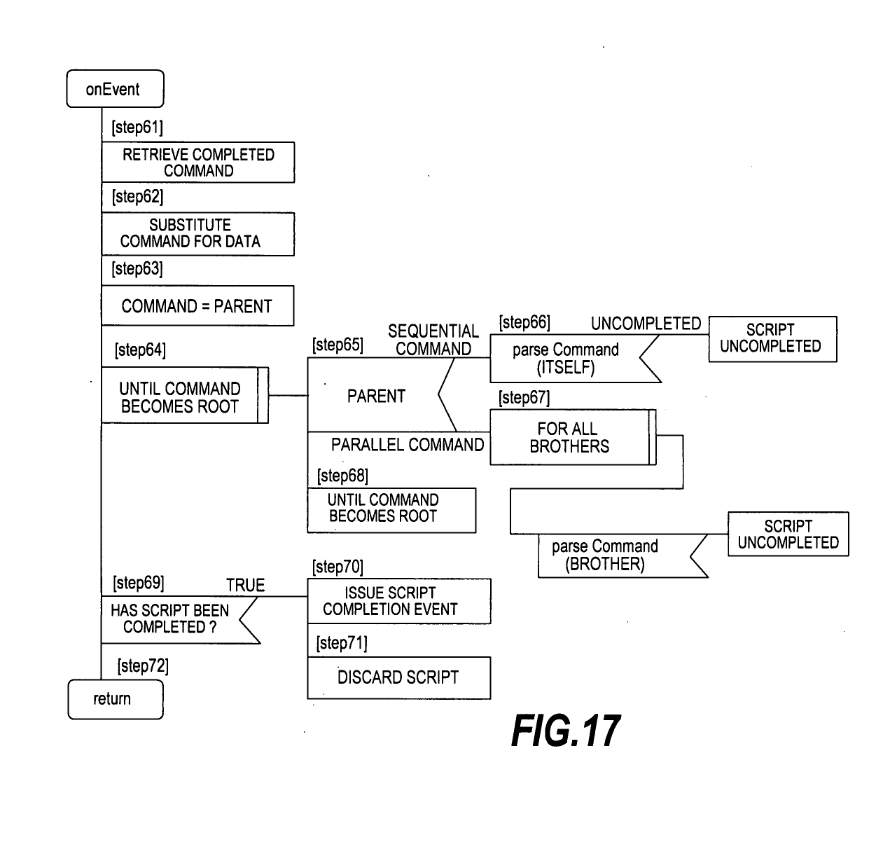

Next, referring to FIG. 17, description will be made of the onEvent interface 911 of the vent publisher 903 to respond to “command execution completion event” when the processing main body of the asynchronous command finishes asynchronous processing.
[step 61] The action ID 113 of the command execution completion event 116 of FIG. 3 is compared with the action ID 1007 of the action handler 1005 registered in the event publisher 903 in the step 33 of FIG. 14 to retrieve the action handler 1005 for managing a target script, and the onEvent interface 1006 of the action handler 1005 is accessed. At the onEvent interface 1006, the command ID 114 of FIG. 3 is compared with the command ID 1106 of FIG. 10 to search for a position of a completed asynchronous command.
[step 62] The command that has been searched for is substituted with data which is its return result.
[step 63] A command (self currently referred to is moved to a position of a parent command of the command that has been searched for.
[step 64] The process of the steps 65 to 68 is repeated until the command (self) currently referred to becomes a root.
[step 65] Determination is made as to whether the parent command is a sequential command or a parallel command.
[step 66] In the case of the sequential command, the parseCommand interface of FIG. 16 is accessed for the self. If a return is “uncompleted”, a flag “uncompleted script” is set to true.
[step 67] In the case of the parallel command, the parseCommand interface of FIG. 16 is accessed for all the brother commands. If a return is “uncompleted”, a flag “uncompleted script” is set to true.
[step 68] The command (self) currently referred to is moved to the parent command.
[step 69] The flag “uncompleted script” is checked. If it is not uncompleted, steps 70 and 71 are executed.
[step 70] A script completion event is issued to the user.
[step 71] The script is discarded.
[step 72] The processing is finished.

<Command System>

General commands used for the script are stored in the command libraries 509, 608, 708, and 811 of the nodes shown in FIGS. 4 to 7.

Examples of commands are as follows.

<progn command and parallel command>
<progn>::= “<progn>” <CommandLine>* “</progn>”
<parallel>::= “<parallel>” <CommandLine>* “</parallel>”

The progn command and the parallel command both execute a group of child commands in sequence. It is to be noted that the progn command is a sequential command, and the parallel command is a parallel command.

<if command>
<if>::= “<if>” <condition-Param> <then-CommandLine>
[<else-CommandLine>] “</if>”
<condition-Param>::=<Param>
<then-CommandLine>::=<CommandLine>
<else-CommandLine>::=<CommandLine>

The if command executes condition determination. In the example, if conditions of a first child are true, a second child is executed. A third child is executed otherwise. Nothing is executed if there is no third child. The if command returns a result of the first child.

<asyncro command>
<asyncro>::= “<asyncro delay=’”NUMBER“’>”
<CommandLine>
“</asyncro>”

The asynchro command is an asynchronous command for executing a child after standing by for several seconds designated in attribute delay.

<When command>
<when>::= “<when event=’”TEXT“’>” [<condition-Param>
[<then-CommandLine>]] “</when>”

The “when command” is an asynchronous command for standing by for an event. When an event of a name designated in attribute event arrives, condition evaluation of the first child is executed. If a result is true, the event is returned to finish the processing. If there is a second child, the second child is executed before the end. If there are no first or second children, the event is unconditionally returned to finish the processing.

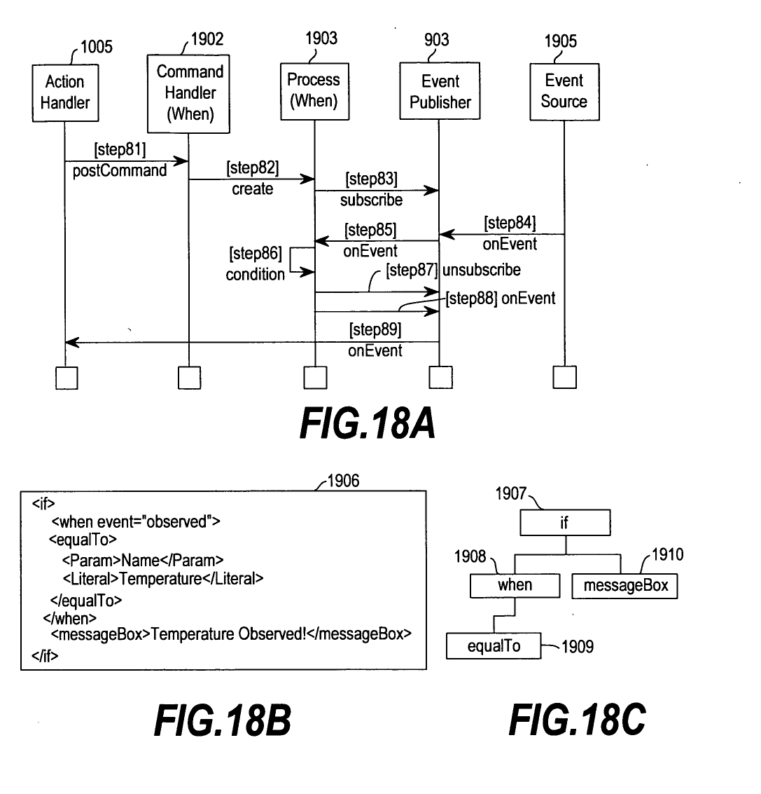

Referring to a sequential diagram of FIG. 18A to FIG. 18C, an operation of the when command will be described. A command handler (When) 1902 is one of command handlers 1009 of FIG. 9, a When process 1903 is event handler mounting, and one of event handlers 1012 in the event publisher 903, and an event source 1905 is an optional event generation source.

A sample script for explaining the when command is indicated by 1906. This is a script for outputting a message of “Temperature Observed” as a standard output if an event parameter Name is Temperature when a type of event called observed arrives. The script 1906 is formed into a structure where a when command 1908 and a messageBox command 1910 are present below an if command 1907 and an equalTo command 1909 is present below the when command 1908 to constitute a tag tree 1008. This script is executed through the following steps.
[step 81] A postCommand interface of the command handler (When) 1902 is accessed from the action handler 1005. This corresponds to the step 53 of FIG. 16.
[step 82] The command handler (When) 1902 generates a When process 1903 which is event handler mounting. This corresponds to the step 45 of FIG. 15.
[step 83] The When process 1903 makes reservation to the event publisher 903 to access itself when a type of event described in attributes of the when command 1908 arrives.
[step 84] The event source 1905 issues an event to the event publisher 903.
[step 85] The event publisher 903 distributes the event to the When process 1903 registered in the step 83.
[step 86] The When process 1903 executes condition determination according to rules described in child elements of the when command 1908.
[step 87] When conditions are true, the When process 1903 cancels the event distribution reservation made to the event publisher 903 in the step 83. By omitting the step 87, a command “whenever” for continuously standing by for events can be mounted for continuously generated events.
[step 88] The When process 1903 issues a command execution completion event to the event publisher 903.

[step 89] The event publisher 903 distributes the command execution completion event from the action ID 113 of the command execution completion event to the target action handler 1005 pre-registered in the step 33 of FIG. 14. Thus, the onEvent interface of FIG. 17 is accessed to continue the processing.

<whenever command>
<whenever>::= “<whenever event=’”TEXT“’>” [<condition-Param>
[<then-CommandLine>]] “</whenever>”

The whenever command is an asynchronous command for continuously standing by for events. A difference from the when command is that while the when command stands by only once for an event such as “report when Yamada comes”, the whenever command stands by for event which come by a plurality of times such as “report when temperature increases/decreases by a unit of 1° C. An operation of the whenever command is similar to that of the “when command”. However, the script containing the whenever is not finished.

killAction command
<killAction>::= “<killAction id=’” NUMBER “’ />”

A killAction command forcibly finishes a script being executed designated by an attribute id. A script in a state of waiting for a return of an asynchronous command such as the when command is forcibly finished. The whenever command can be forcibly finished only by this command. The id to identify the script is the action ID 1007 of FIG. 9, and can be presented as a last return of the postaction interface of FIG. 14 to the user or an upper system (upper node).

<set command>
<set>::= (“<set>” “<XPath>” <XPath> “</XPath>”
<CommandLine> “</set>”) | (“<set XPath=’”
<XPath> “’> ”<CommandLine> “</set>”)

The set command sets a variable in which the inside of the script is a scope. The <XPath> is an index indicating a position of a variable designated by XPath which is a language standardized by W3C to represent a position of an XML document. For example, a temperature of a 2nd room of a 1st building can be represented by Building [1]/Room [2]/Temperature. In the XRoute, a single variable such as Temperature can be used, or a primary arrangement such as Room[2] can be used. A global set command may be defined in which a scope is among a plurality of scripts. A set command may be defined to substitute a database with values.

In addition, the set command may include commands such as a get command for obtaining the variable designated by the <XPath> and set by the set command, a plus command, a minus command, a multiply command and a divide command for four operations, a sum command for taking one or more children to obtain a total, and an average command for taking one or more children to obtain an average value.

<Communication Command>

The inter-node communication function indicated by the command execution request 112 of FIG. 3 can be realized by a communication command “ask” which is one of the asynchronous commands of this invention.

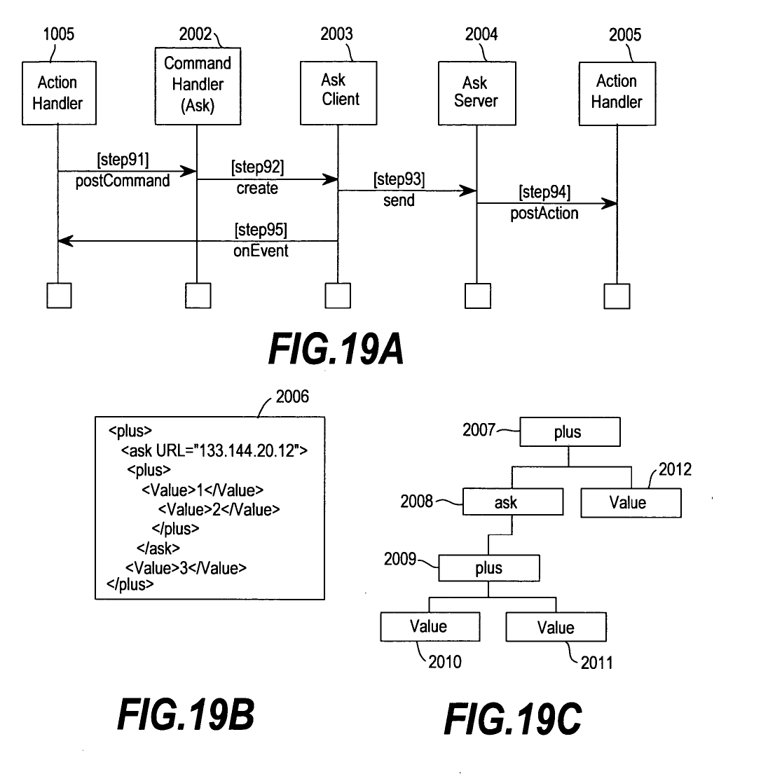

Referring to a sequential diagram of FIG. 19A to FIG. 19C, an operation of the ask command will be described. A command handler (Ask) 2002 is one of the command handlers 1009 of FIG. 9, and an Ask client 2003 is a communication client to communicate with an Ask server 2004 on a communication system (communication destination node). An action handler 2005 is an action handler 1005 on the communication system.

A sample script for explaining the Ask client 2003 and the Ask server 2004 is indicated by 2006. This is a script for executing four operations (1+2)+3, and the four operation (1+2) part is carried out by the communication system. The script 2006 is formed into a structure where an ask command 2008 and Value data 2012 are present below a plus command 2007, a plus command 2009 is present below the ask command 2008, and Value data 2010 and 2011 are present below the plus command 2009 to constitute a tag tree 1008. This script is executed through the following steps.
[step 91] A postCommand interface of the command handler (Ask) 2002 is accessed from the action handler 1005. This corresponds to the step 53 of FIG. 16.
[step 92] The command handler (Ask) 1902 generates an Ask client 2003 which is a communication client. This corresponds to the step 45 of FIG. 15.
[step 93] The Ask client 2003 transmits partial scripts (2009, 2010, and 2011) which are children to the communication destination system of an address described in ask command attributes.
[step 94] The Ask server 2004 of the communication destination system requests script execution to the action handler 2005 of the communication destination system. This corresponds to the accessing of the postaction interface of FIG. 14. A script 2009 includes a synchronous command only. Accordingly, its result is immediately returned, and the result is returned to the Ask client 2003.
[step 95] The Ask client 2003 issues a command execution completion event to the event publisher 903 (not shown). The event publisher 903 distributes the command execution completion event from the action ID 113 of the command execution completion event to the action handler 1005. Thus, the onEvent interface is accessed to continue the processing.

The distribution/registration of the event handlers indicated by the actions 406, 410 and 415 of FIG. 2 can be realized by distributing the when command by the ask command of this invention.

In other words, the communication command transmits a communication command which is a child command, a command identifier, and an identifier of a communication source node to the communication destination node, and then finishes a parent command of the communication command in an uncompleted state. Then, the processing stands by until an execution result is returned from the communication destination node, and resumes the execution of the parent command corresponding to the command identifier finished in an uncompleted state upon the return of the execution result and the command identifier from the communication destination node, thereby realizing transmission/reception.

<Asynchronous Event Standby Command>

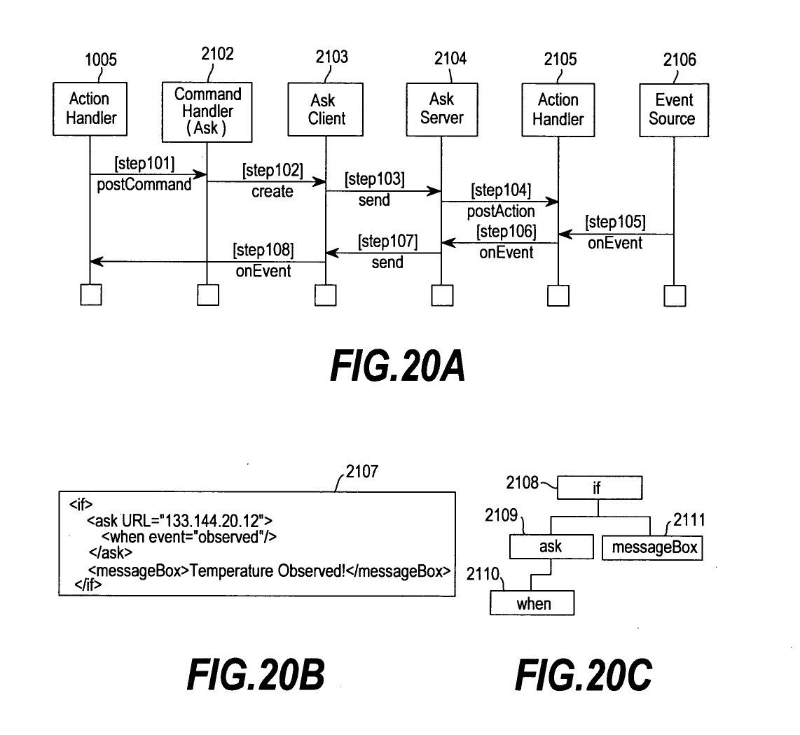

Referring to FIG. 20A to FIG. 20C, an example of installing the asynchronous event standby command when of FIG. 18A to FIG. 18C in the child command of the asynchronous communication command ask of FIG. 19A to FIG. 19C will be described. A command handler (Ask) 2102 is one of the command handlers 1009 of FIG. 9, and an Ask client 2103 is a communication client to communicate with an Ask server 2104 on the communication destination system (communication destination node). An action handler 2105 is an action handler 1005 on the communication destination system, and an event source 2106 is an optional event generation source on the communication destination system.

A sample script for explaining this is indicated by 2107. This performs an operation of standing by for an event observed at the communication destination system, and displaying a message at the communication source system when a return comes. The script 2107 is formed into a structure where an ask command 2109 and a messageBox command 2111 are present below an if command 2108 and a when command 2110 is present below the ask command 2109 to constitute a tag tree 1008. This script is executed through the following steps.
[step 101] A postCommand interface of the command handler (Ask) 2102 is accessed from the action handler 1005. This corresponds to the step 53 of FIG. 16.
[step 102] The command handler (Ask) 2102 generates an Ask client 2103. This corresponds to the step 45 of FIG. 15.
[step 103] The Ask client 2103 transmits a partial script (2110) which is a child to the communication destination system.
[step 104] The Ask server 2104 of the communication destination system requests script execution to the action handler 2105 of the communication destination system. This corresponds to accessing of the postaction interface of FIG. 14.
[step 105] The event source 2104 of the communication destination distributes an event to the event publisher 903 of the communication destination (not shown in FIG. 20A to FIG.20C). The event publisher 903 lastly distributes a command execution completion event to the action handler 2105.
[step 106] The action handler 2105 distributes a script execution completion event to the Ask server 2104 of the action execution source.
[step 107] The Ask server 2104 of the communication destination system distributes the command execution completion event to the Ask client 2103 of the communication source system.
[step 108] The Ask client 2103 of the communication source system issues the command execution completion event to the event publisher of the communication source (not shown in FIG. 20A to FIG. 20C). The event publisher 903 lastly distributes the command execution completion command to the action handler 2101. Thus, the onEvent interface is accessed to continue the processing.

<Parallel Command>

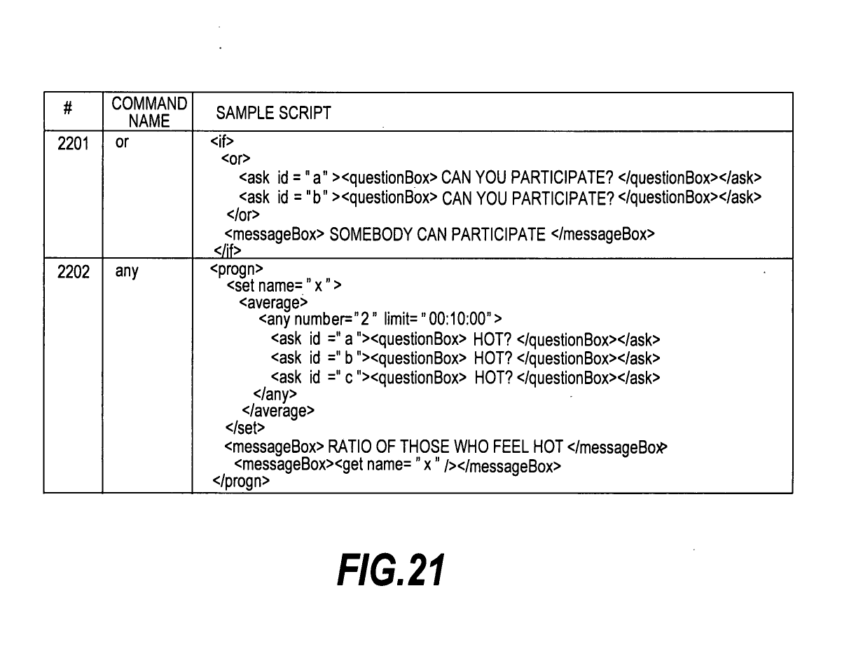

Next, referring to FIG. 21, a logical or command “or” and a deadline command “any” that are preferable expansion of the parallel command of this invention will be described.

In FIG. 21, 2201 indicates a sample script for explaining an operation of a parallel logical or command “or”. This is a script for requesting distribution/execution of a question/response request command questionBox which is an asynchronous command to the clients 205 whose id's are identified by a, b and b, and outputting a message if one of the responses is true. It is to be noted that the questionBox command is a command for casing the user who operates the client to press a “YES” or “NO” button to return true or false.

As the “or command” is a parallel command, questions can be simultaneously issued to a plurality of clients. Because of the nature of the logical or, the command is established when one. of the children is true. Accordingly, as its mounting, a command completion event of one of the children comes and, if its value is true, the command can be finished in an uncompleted state before arrival of command completion events of the remaining children. Thus, as the processing can be continued without waiting for all the responses, the processing can be efficiently executed. This can be realized by executing the determination of the step 44 as special mounting of the “or command” of the postCommand interface shown in FIG. 15. Similarly, a logical and command can be mounted.

In FIG. 21, 2202 indicates a sample script for explaining an operation of the parallel deadline command “any”. This is a script for requesting distribution/execution of question/response request commands questionBox which are asynchronous commands as questionnaires simultaneously to the client 205 in which node id's are identified by a, b and c, setting a response deadline number n as two and a response deadline time limit as ten minutes by the any command, and averaging results thereof by an average command, substituting a variable x by a set command, and outputting a standard output by the messageBox command.

The any command is a parallel command. Accordingly, questions can be simultaneously issued to a plurality of clients (nodes). As a questionnaire function, a deadline number and a deadline time can be set. As in the case of the or command, rather than being finished in an uncompleted state when there is an uncompleted child command in the step 44 of the postCommand interface shown in FIG. 15, the any command may move to the step 45 when the completed command reaches the number or when the deadline time is passed.

As another characteristic of the parallel deadline command “any”, a “low reliability problem of node” which has been a problem of the sensor network can be solved. The sensor network is a system which has a concept of laying great many sensor nodes basically low in price to compensate for low reliability of each sensor node by the number, and the fact of no guarantee that a return always comes due to a failure or the like must be taken into consideration. Generally, however, the event handler does not operate at all unless an event is generated. Thus, some measures must be taken to deal with case of not event return.

A phenomenon to be observed is observed simultaneously by the overlapped sensor nodes in anticipation of erroneous detection or failures, and by using the response deadline number of the parallel deadline command “any”, statistically useful events can be extracted.

A logic generally called a Dead Man Switch (DMS) which determines a node failure when there is not periodic communication can be mounted by using the response deadline time of the parallel deadline command “any”.

<Compressed Script>

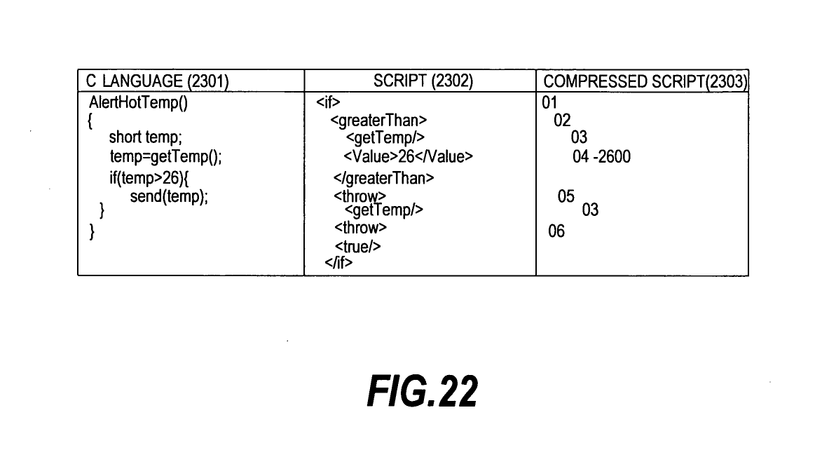

Next, referring to FIG. 22, a compressed script which is preferable expansion of this invention.

Generally, in many cases, the sensor node 201 and the router node 202 of FIG. 2 are realized by hardware less powerful in memory size, CPU processing speed and communication speed as compared with the server 203 from the standpoint of processes and power. In this case, when the script of this invention is described in XML, problems are likely to occurs in communication cost, CPU processing cost, and memory consumption. Accordingly, the script is preferably transmitted by a compressed structure.

A script 2302 of FIG. 22 is a descriptive example of an event handler of the sensor node 201. It is a script of “event is issued when temperature is 26° C. or more”. In the drawing, a greaterthan command is a size comparison command, a getTemp command is a temperature observed value obtaining command, and a throw command is an event issuing command. When described in C language, this script becomes similar to that indicated by 2301 of FIG. 22.

An example of describing this example by a compressed script is indicated by 2303 of FIG. 22. A compression method of this compressed script abides by the following rules.
[rule 21] A command name is mapped on a corresponding command identifier.
[rule 22] When the number of command children is fixed, it is omitted presuming that it is known in both of a compressor and a developer.
[rule 23] When the number of command children is variable, the number of children is written at the head of all the children.

A size of a name space of the command identifier can be freely expanded by using Multi-byte Integers disclosed in the Nonpatent Document “WAP Binary XML Content Format W3C NOTE 24 Jun. 1999”. Moreover, a collision problem of the name space of the command identifier can be solved by transmitting a mapping table of a command name and a command identifier applied by a node at the time of starting the node to the server.

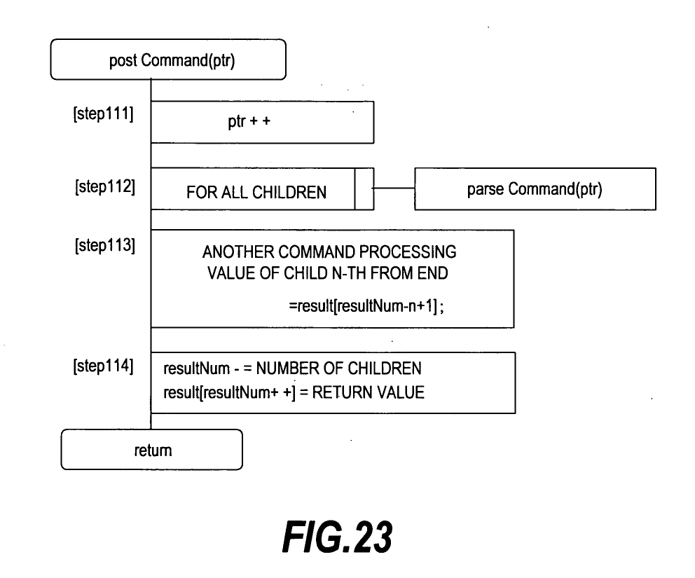

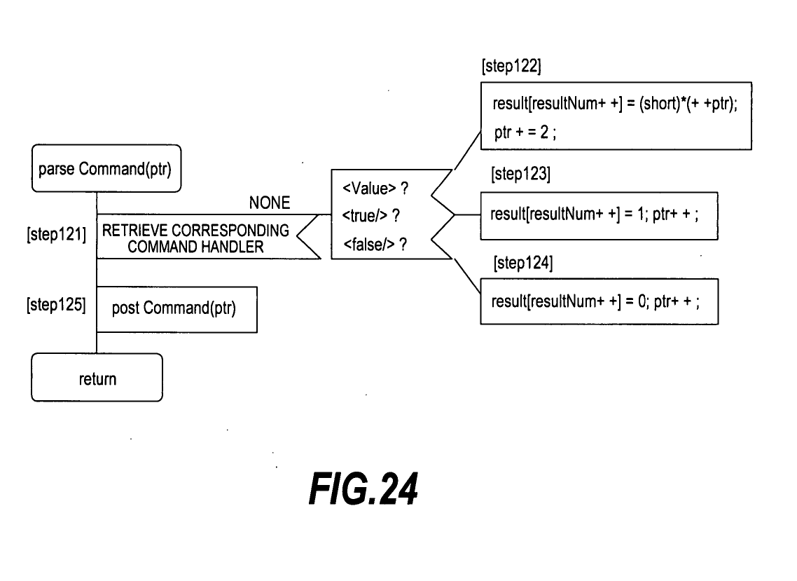

Referring to FIGS. 23 and 24, an algorithm of compressed script execution on the weak hardware will be described.

By using the algorithm, it is not necessary to unfold the compressed script in a tree structure, and the script can be processed only by using an arrangement result having a size corresponding to the number of child commands.

FIG. 23 shows mounting of the postCommand interface 914 of the command handler 1009 of FIG. 9 in the compressed script on the weak hardware, and corresponds to FIG. 15.
[step 111] Increment a pointer ptr of the compressed script by an amount equal to the command identifier.
[step 112] Access the parseCommand of FIG. 24 by a number of times equal to the predefined number of children.
[step 113] Another processing of the self command is executed. A value of a child nth from the end is stored in the storage number resultNum-n+1 of the arrangement result.
[step 114] Reduce the storage number of arrangement results by an amount equal to the number of children, store a return value of the self command, and increment the storage number by 1.

FIG. 24 shows mounting of the parsecommand interface 1018 of the command handler 1005 of FIG. 9 in the compressed script on the weak hardware, and corresponds to FIG. 16.
[step 121] Search for a command handler 1009 of a command corresponding to a value of the pointer ptr of the compressed script. When there is not relevant result, the processing proceeds to steps 122 to 124.
[step 122] When the value of the pointer ptr of the compressed script is data <Value>, as a next value is data, the data is added to the arrangement result, and the ptr is advanced by an amount equal to the command identifier and a data size.
[step 123] When the value of the pointer ptr of the compressed script is a true/false value <true/>, the true value is added to the arrangement result, and the ptr is advanced by an amount equivalent to the command identifier.
[step 124] When the value of the pointer ptr of the compressed script is a true/false value <false/>, the false value is added to the arrangement result, and the ptr is advanced by an amount equivalent to the command identifier.
[step 125] Access the postCommand interface of the corresponding command handler 1009 shown in FIG. 23.

As described above, according to this invention, as dynamic changes of the operation flow of distributed event handling on the sensor network nodes can be made corresponding to user objects which are present by a plurality, cannot be generalized but dynamically changed, diverse user objects can be reflected on a single sensor network. Thus, since installation/maintenance costs can be shared among a plurality of users, it is possible to realize a large sensor network infrastructure for making observations over wide regions.

This invention enables dynamic changing of the operation flow of distributed event handling corresponding to a dynamically changed situation. Thus, as compared with the case of executing the prefixed event handling, it is not necessary to execute useless processing, whereby the number of events to be distributed can be reduced. Accordingly, it is possible to reduce load concentration in the server.

Furthermore, the script having the command of the tree structure is instructed from the client 205 to the sensor network to enable easy control of the plurality of nodes. As the user only needs to define one script, it is possible to use desired information very easily from the sensor network which includes great many sensor nodes 201. Moreover, by properly changing the script, it is possible to easily change the information of the sensor network used according to a change in user request.

<Second Embodiment>

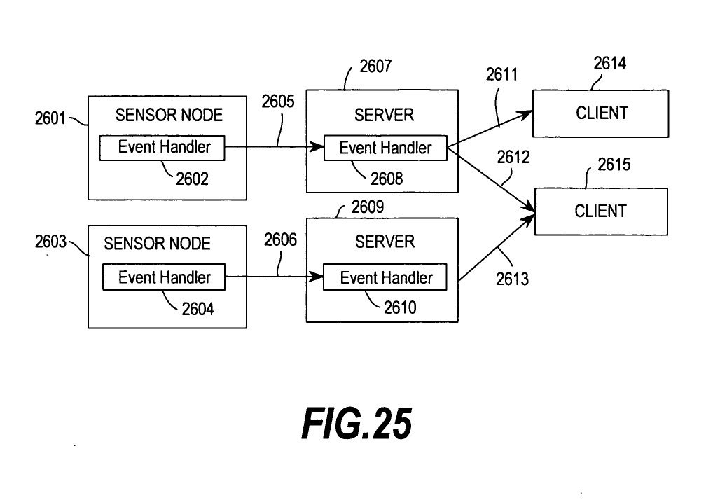

FIG. 25 shows a sensor network which includes a plurality of clients having different objects according to a second embodiment.

Referring to FIG. 25, the sensor network including a sensor node 2601, a server 2607, and clients 2614 and 2615 having different objects is presumed. By requests from the clients 2614 and 2615, different events are processed by an event handler 2602 on the sensor node 2601 to issue two types of secondary events 2605. Other components are similar to those of the first embodiment, the sensor nodes 2601 and 2607 are similar to those of the first embodiment sown in FIG. 4, ands the server 2607 is similar to the server 203.

Now, a “secondary event identifier problem” which has been a problem of the conventional sensor network and its solution will be described.

Generally, the event 2605 includes an identifier for identifying a type of an event, and an event parameter. In this case, a problem as to who decides the identifier for identifying the type of an event occurs. The identifier cannot be decided by the client 2615. It is because there is a possibility of identifier collision between the different clients 2614 and 2615. However, management of identifiers cannot be unified by the server 2607 to dynamically allocate them. It is because there is a possibility of identifier collision between the servers 2607 and 2609 which cover different areas. An identifier of a secondary event cannot be standardized. It is because the standardization of the identifier of the secondary event means fixing of rules of an event handler by a standardized organization, causing a reduction in user's freedom of creating event handlers. Those problems are solved by using a combination of an identifier for uniquely identifying an event request source client and an identifier freely decided by the client as an identifier of a secondary event. However, a size of the identifier of the secondary event is increased, and its application to a sensor network field based on the assumption of handling great many events is not realistic.

According to this invention, as shown in FIG. 3 of the first embodiment, the secondary event is replaced by the action completion event 116 which is a return of the asynchronous action, and an event return destination is decided by the action ID 113 and the command ID 114. Accordingly, the secondary event identifier problem will not occur.

Referring to FIG. 25, an “event leakage problem” that has been a problem of the conventional sensor network and its solution will be described.

A secondary event 2605 output as a result of information processing at the event handler 2602 of the sensor node 2601 is valuable information created corresponding to a user request, and it should not be leaked to other users having opposite advantages. When the event 2605 is bugged on a communication route, there is a possibility of leakage of an event type and an event return destination.

According to this invention, as shown in FIG. 3, the action completion event 116 does not contain information indicating an event type, or an identifier for uniquely identifying the event request source client. Thus, the problem will not occur.

<Third Embodiment>

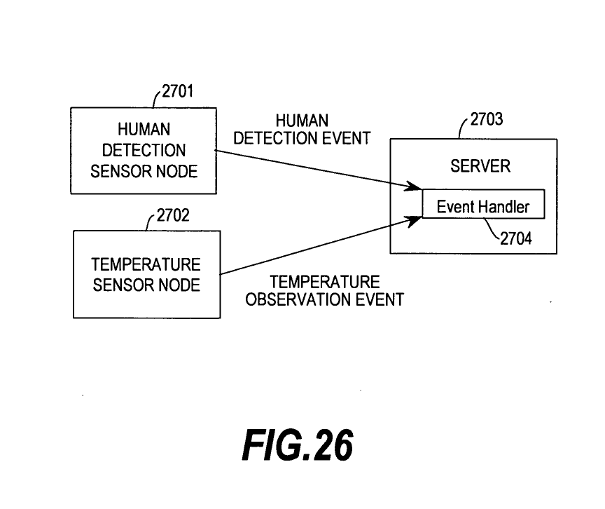

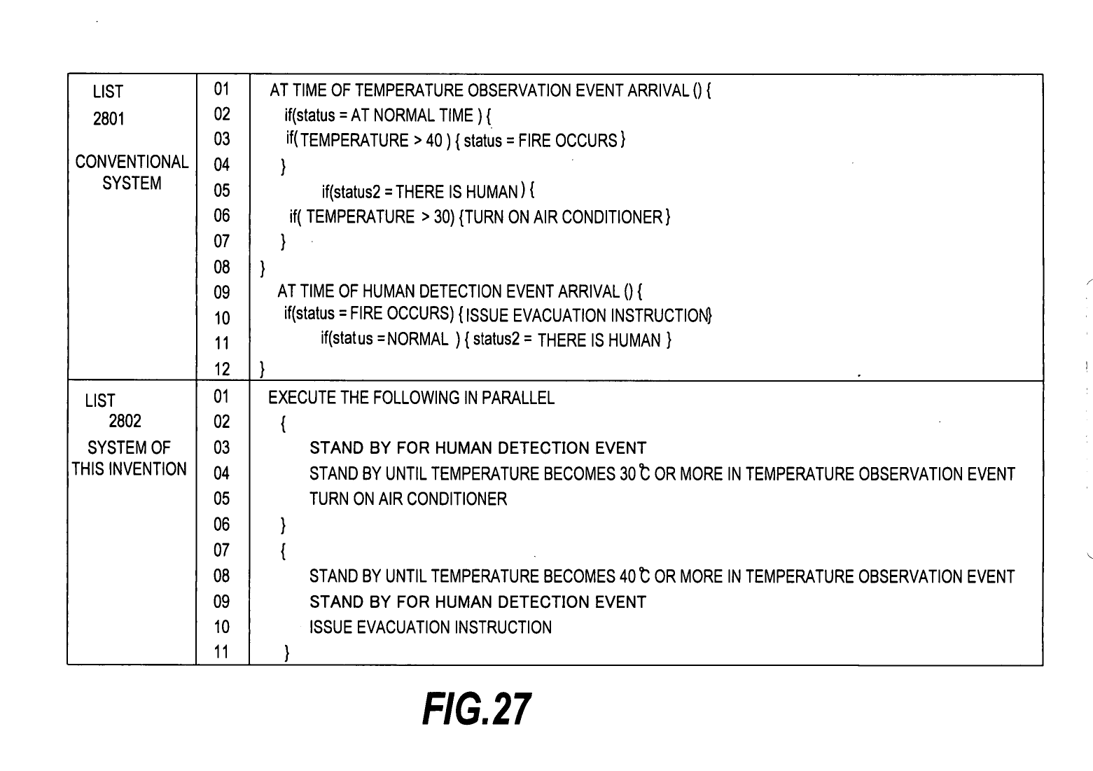

FIGS. 26 and 27 shows an example where one client handles a plurality of sensor nodes by a plurality of rules according to a third embodiment.

Referring to FIG. 26, a sensor network includes a human detection sensor node 2701 for issuing a “human detection event”, a temperature sensor node 2702 for issuing a “temperature observation event”, and a server 2703 having an event handler 2704 mounted thereon to receive those events. Other components are similar to those of the first embodiment. The sensor nodes 2701 and 2702 are similar to the sensor node 201 of the first embodiment, and the server 2703 is similar to the server 203 of the first embodiment.

Consideration will be given to a case of mounting the following rules in the event handler 2704 of the server 2703.
[Rule 31] An air conditioner is started when a room in which a human is present is at 30° C. or more.
[Rule 32] When a room temperature is 40° C. or more, fire is determined to issue an evacuation order if there are humans.

Now, a “rule number explosion problem” that has been a problem of the conventional sensor network and its solution will be described. Generally, the event handler manages N state variables, receives M types of events, and makes state transition. In this case, the number of rules of state transition to be described becomes N×M or more. Thus, an event handler creator may forget to describe a rule, creating a possibility of unintended actions. This is called a rule number explosion problem.

According to the conventional example, the event handler is described as in the case of a list 2801 of FIG. 27. As the list 2801 originally focuses on events, the rules are not easily represented, causing low readability. A plurality of state variable and conditions must be determined. An increase in the number of state variables or events causes an explosive increase in complexity of the list 2801, and it can be easily imagined that a probability of rule description omission of the event handler creator will be increased.

By using the parallel command and the asynchronous standby command of the first embodiment as scripts of this invention, it is possible to describe the rules as in the case of the list 2802. The list 2802 can easily represent the rules, and remove the state variables. Thus, it is possible to suppress rule description omission of the event handler creator.

<Fourth Embodiment>

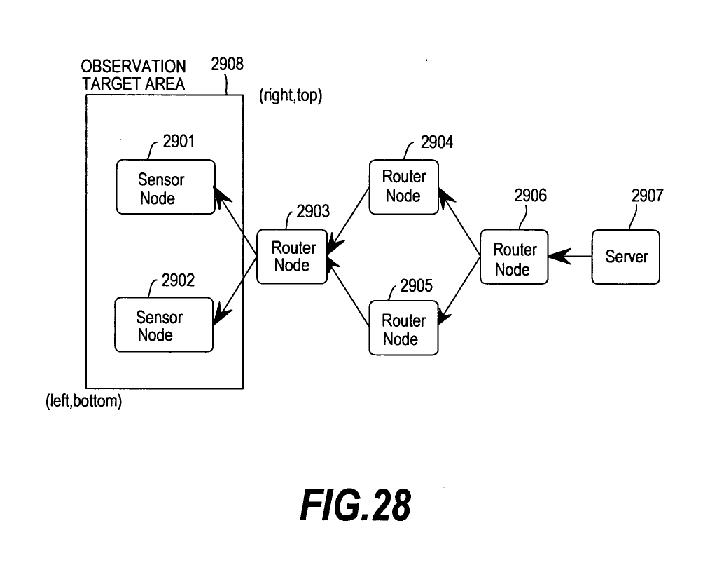

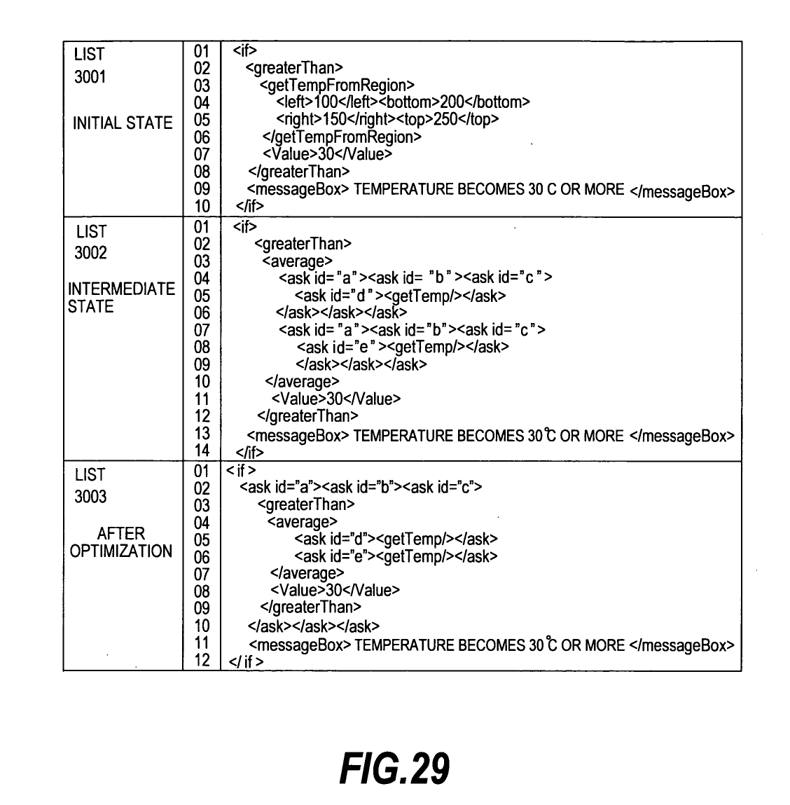

FIGS. 28 and 29 show a case of a dynamic change in configuration between nodes according to fourth embodiment.

Referring to FIG. 28, it is presumed that sensor nodes 2901 and 2902 are connected to a server 2907 via router nodes 2903, 2904, 2905, and 2906. In this case, a function is provided which causes the sensor nodes 2904 and 2905 to output messages when an average temperature of an observation target area 2908 designated by a user deviates from a designated value. The router nodes 2904 and 2905 are arranged in parallel.

The sensor nodes 2901 and 2902 are similar to the sensor node 201 of the first embodiment, the router nodes 2903 to 2906 are similar to the router node 202 of the first embodiment, and the server 2703 is similar to the server 203 of the first embodiment.

The conventional sensor network has an “Ad-Hoc problem”, and now its solution will be described. The sensor network is basically a network system having Ad-Hoc characteristics. In other words, there is a possibility that positions, the number or efficiency of sensor nodes to be used will change by timing uncontrollable by a user because of failures of the sensor nodes, addition/movement/removal of sensor nodes or the like. Accordingly, an operation flow must be dynamically created according to a situation during running rather than being created beforehand by the user.

Referring to FIG. 28, a most preferable system for preventing load concentration in the server 2907 and minimizing the amount of communication is a system which collects observed values of the sensor nodes 2901 and 2902, and executes averaging and designated value deviation determination by the event handler of the router node 2903. However, the observation target area 2908 changes according to a user object or a situation, and the corresponding sensor nodes 2901 and 2902 and the router nodes 2903 to 2906 change in configuration. Thus, the change of the sensor network must be automatically changed, thereby setting an optimal operation flow in each node.

According to this invention, as an operation flow between the dispersed nodes can be described as a single script, the operation flow can be changed only by changing the script.

Referring to FIG. 29, a script changing system will be described.

A list 3001 is an example of a script whose execution is requested by the user to the server 2907. A getTempFromRegion command obtains an average temperature of a rectangular area (observation target area 2908) designated by a child. Accordingly, when the average temperature of the rectangular observation target area 2908 exceeds 30° C., the list 3001 displays a message “temperature is over 30° C.”.

A processing main body of the getTempFromRegion command mounted on the server 2907 includes a node search unit for searching for the sensor nodes 2901 and 2902 included in the observation target area 2908, and a route search unit for searching for an optimal route (router node) 2906-2904-2903-2901 or 2906-2904-2903-2902 to enable communication to reach the sensor node group. For the node search unit and the route search unit, for example, an Ad-hoc On-demand Distance Vector (SODV) employed in an Ad Hoc radio communication standard ZigBee can be used.

A list 3002 can be obtained by using the node search unit and the route search unit for the list 3001 of FIG. 29 to deform the script. The getTempFromRegion command from a 3rd line to a 6th line of the list 3001 is replaced by that of 3rd to 10th line of the list 3002. In this case, the command from 4th to 6th line of the list 3002 requests execution of a temperature observation event getTemp to the sensor node 2901 via the route 2906-2904-2903-2901. The command from 7th to 9th line of the list 3002 requests execution of the temperature observation command getTemp to the sensor node 2902 via the route 2906-2904-2903-2902. The command of the 3rd line of the list 3002 calculates an average of child returns by an average calculation command average.

A list 3003 can be obtained by applying the following rules to the list 3002 to deform the script. Basic rules for deforming the script are an exchange rule and a distribution rule well known in a mathematical field.
[rule 31] Distribution rule: AB·AC=A(B·C)
[rule 32] Exchange rule: A·B=B·A

The following rules are used as application conditions of the exchange and distribution rules.
[rule 33] The exchange rule [rule 31] can be applied to a communication command and a parent command thereof when the communication command has no brother commands, and there is a guarantee that the parent command will equally operate at a communication source node and a communication destination node.
[rule 34] The exchange rule [rule 31] can be applied when the communication command has brother commands, and there is a guarantee that all the brother commands will equally operate at the communication source and destination nodes.
[rule 35] The exchange rule [rule 32] can be applied when the communication command has equal communication commands for the communication destination as brother commands.

By applying those rules, the commands of the 4th and 7th lines of the list 3002 are collected to move between the 1st and 2nd lines of the list 3002. Accordingly, for the list 3003, averaging and designated value range determination are executed at the router node 2903 via the route 2906-2904-2903, whereby the most preferable operation flow according to the running situation can be obtained.

By selecting a sensor group sufficient for the request accuracy from a plurality of sensor nodes present in a space area designated by the script, the node search unit can integrate the observation results of the sensor nodes in the space area to obtain a characteristic amount of the space area.

<Fifth Embodiment>

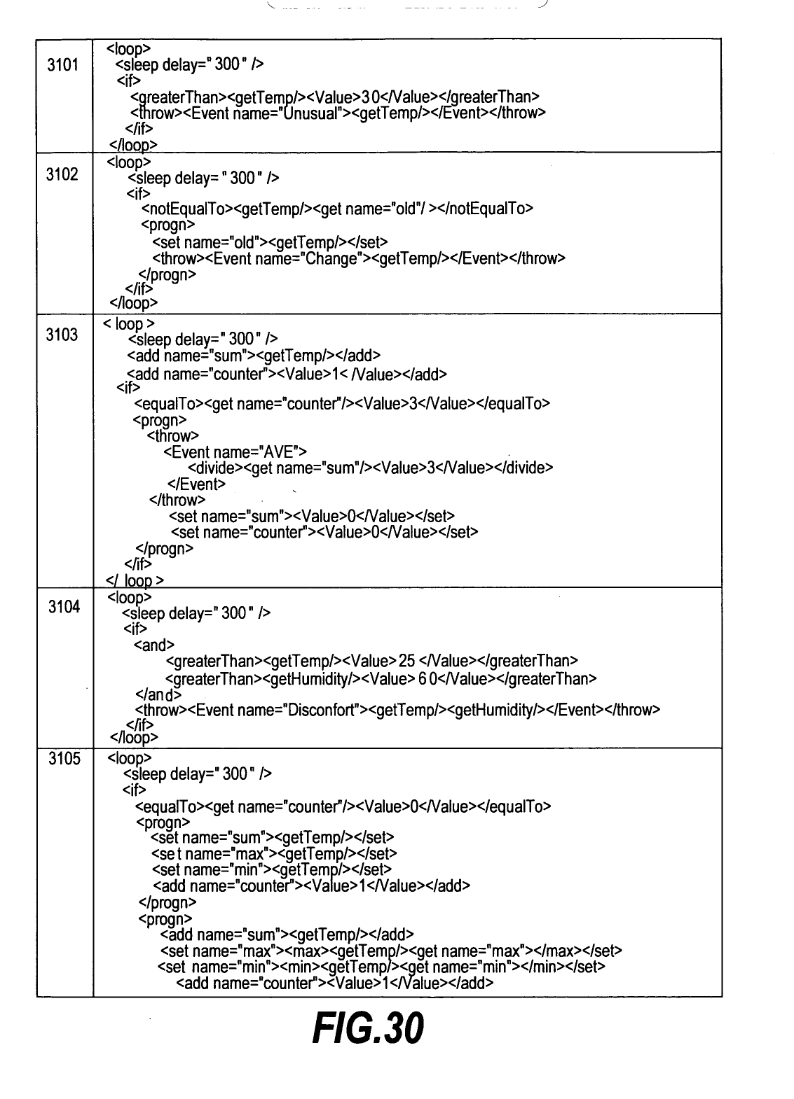

FIG. 30 shows an example of a script according to a fifth embodiment capable of changing a behavior of the sensor node 201 of the first embodiment. A configuration of a sensor network is similar to that of the first embodiment.

A list 3101 of FIG. 30 is a script describing a rule of transmitting an event when an observed value exceeds a threshold value. First, children are repeated by a loop command. Next, the process pauses for a time designated in delay attributes by a sleep command, and then issues an unusual event when a temperature observed by a getTemp command exceeds 30° C.

A list 3102 is a script describing a rule of transmitting an event when the observed value changes. When the temperature obtained by the getTemp command changes from temperature history of an old key, a Change event is issued.

A list 3103 is a script describing a rule of transmitting a time average value. After observations of three times, an AVE event having its average value is issued.

A list 3104 is an example of condition determination of a plurality of observed values of a temperature and a humidity. When the temperature exceeds 25° C. and the humidity exceeds 60%, a Discomfort event is issued.

A list 3105 is a script describing a rule of transmitting a maximum value/minimum value/average value.

The scripts of the lists 3101 to 3105 are transmitted to the sensor node 201, and execution is requested, whereby a behavior of the sensor node can be dynamically changed during the sensor network running. Thus, the sensor network can be flexibly run.

<Sixth Embodiment>

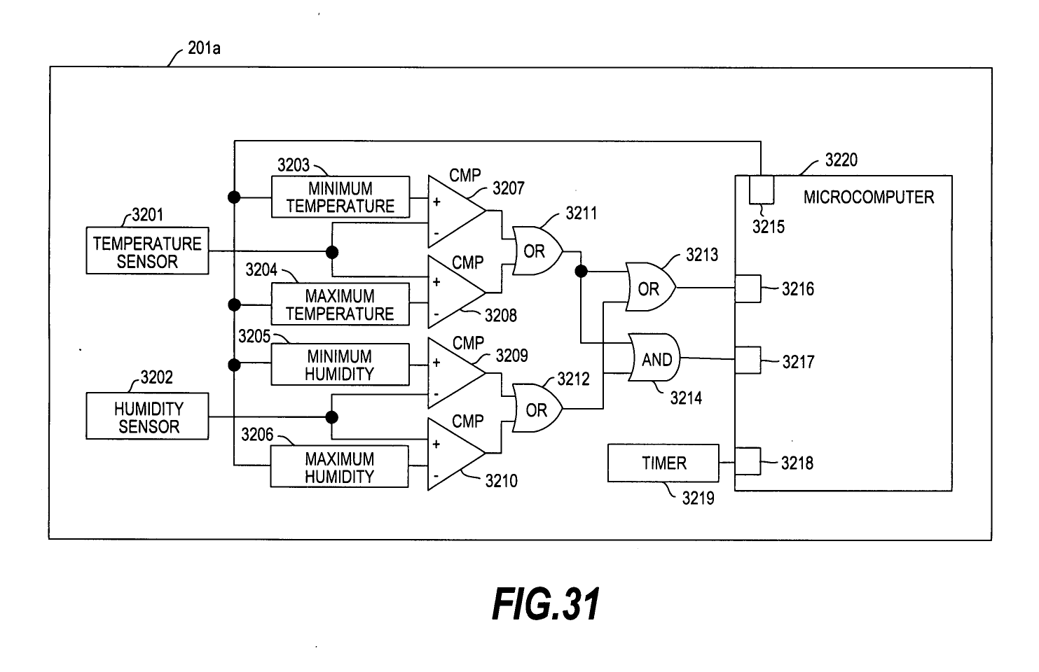

FIG. 31 shows main sections of a sensor device and a microcomputer according to the sixth embodiment when the sensor node 201 of the first embodiment is set as an energy conservation type. Other components are similar to those of the first embodiment shown in FIG. 4.

A microcomputer 3220 constituting the sensor node 201 can generally switch modes between a pause mode of little power consumption and an active mode of much power consumption. The microcomputer 3220 of the pause time changes to the active mode by interruption from an interruption port.

An interruption mode 3218 for connecting with a timer is disposed, and the microcomputer changes to the active mode by timer interruption to continue script processing, whereby a script purser driven by a time event can be realized.

For example, as mounting of a sleep command which is an asynchronous pause command described in a 2nd line of the list 3101 of FIG. 30, a pause time is set in a timer 3219, the command ID of FIG. 3 is stored, the microcomputer is changed to a pause state and, when the microcomputer is actuated, processing is resumed from the stored command ID. Accordingly, it is possible to realize a highly energy efficient sensor node which changes to an active mode only at observation time.

Similarly, an arithmetic operation circuit for simple comparison/logical determination of an observed value and a fixed value is mounted by hardware, whereby a script purser driven by an observed value event can be realized.

Referring to FIG. 31, a sensor node 201a includes a temperature sensor 3201 and a humidity sensor 3202, and upper and lower limit values of outputs of the sensors are compared by comparators 3207 to 3210. Then, outputs of the comparators 3207 to 3210 are determined by an OR gate and an AND gate to be input to the microcomputer 3220.

In the microcomputer 3220, one or both of interruption ports 3216 and 3217 are disposed. In the case of the interruption port 3216, interruption occurs when “a temperature observed value exceeds a designated range or a humidity observed value exceeds a designated range. In the case of the interruption port 3217, interruption occurs when “a temperature observed value exceeds a designated range and a humidity observed value exceeds a designated range”.

The temperature sensor 3201 and the humidity sensor 3202 always output voltages indicating observed values. A reference voltage generation circuit of lower and upper limit temperatures 3203 and 3204 and lower and upper limit humidities 3205 and 3206 outputs a predefined reference voltage by a selection signal from an output port 3215 of the microcomputer. Comparators 3207 to 3210 compare input voltages, and output voltages indicating true values when a (+) input voltage is higher than a (−) input voltage.

The reference voltage generation circuits 3203 to 3206 can be constituted of, e.g., band gap reference circuits. For the band gap reference circuit, for example, a circuit described in page 4 of “10-bit 80MSPS 1ch D/A converter” of <http://www.sony.co.jp/˜semicon/japanese/img/sonyj01/e6801283.pdf> can be applied. An independent constant voltage source output terminal using the band gap reference is connected to VREF, whereby a stable voltage nondependent on a power supply voltage is obtained.

The comparator 3207 returns true when the observed temperature drops below the lower limit temperature. The comparator 3208 returns true when the observed temperature exceeds the upper limit temperature. The comparator 3209 returns true when the observed humidity drops bellow the lower limit humidity. The comparator 3210 returns true when the observed humidity exceeds the upper limit humidity. OR circuits 3211 to 3213 output true when logical or of inputs is true. An AND circuit 3214 outputs true when logical and of inputs is true.

Thus, the arithmetic operation circuit for simple comparison/logical determination of the observed value and the fixed value can be mounted by the hardware. As the processing of the sensor node 201a can be stopped when unnecessary, power consumption of the sensor node 201a can be suppressed. Especially in application to a movable radio type sensor node 210a, it is possible to prolong a charging cycle and a life of a battery.

<Seventh Embodiment>

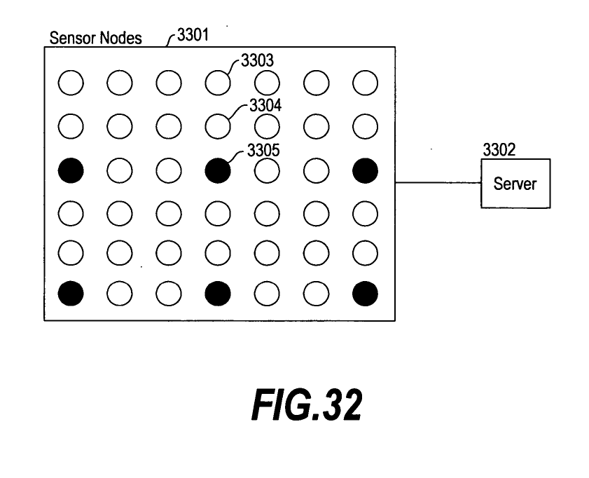

FIG. 32 shows a sensor network usable under both normal and emergency situations according to a seventh embodiment. A sensor node, a server and the like are constructed as similar to those of the first embodiment. Though not shown, a plurality of router nodes may be disposed between a sensor node 3301 and a server 3302.

This invention can provide a sensor network capable of changing an operation flow of an event handler according to a situation. The sensor network has significance in terms of having a potential for obtaining environment information necessary in case of emergency as well as in terms of constantly obtaining observed information of a wide environment. For example, in the event of disaster such as an earthquake, a fire or water damage, there is a great significance in a radio network with a node having an own power source when a power network is cut off. However, constructing the sensor network only for emergency purpose is not cost-effective. Preferably, the sensor network should also be used under a normal situation. Information on a particle size (space interval and time interval) necessary for emergency is generally unnecessary at normal times, so it is a waste of power to always obtain unnecessary information.

Referring to FIG. 32, a function of the sensor network usable under both normal and emergency situations will be described. At normal times, rather than operating all the sensor nodes in an observation target area 3301, for example, a sensor node of a space interval sufficient for environment monitoring (back node 3305 in the drawing) alone is operated. To average power consumption, a periodically operated sensor node group 3301 may be replaced by a nonoperated node. In case of emergency, all the sensor nodes may be operated to collect pieces of environment information in detail. For example, a sensor node 3304 alone near a critical spot 3305 such as a neighborhood of a fire occurrence point may be operated. Examples of such a sensor network include a sensor network in which a human detection sensor installed in a building is used for congestion state monitoring at normal times and for discovering people to be evacuated at the time of fire occurrence, a sensor network in which an acoustic sensor node installed in a mountain or forest is used for monitoring an animal habitat situation at normal times and for discovering casualties in case someone go missing, and a sensor network in which a sea water temperature sensor disposed in a buoy of a coast is used for academic purposes at normal times and for lowering a marine culture bag to prevent scallop from being died in case of abnormal temperature.

<Eighth Embodiment>

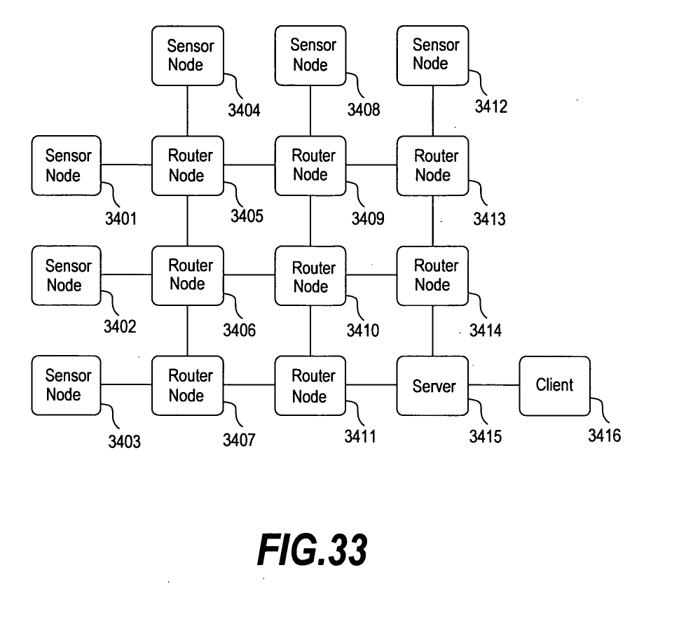

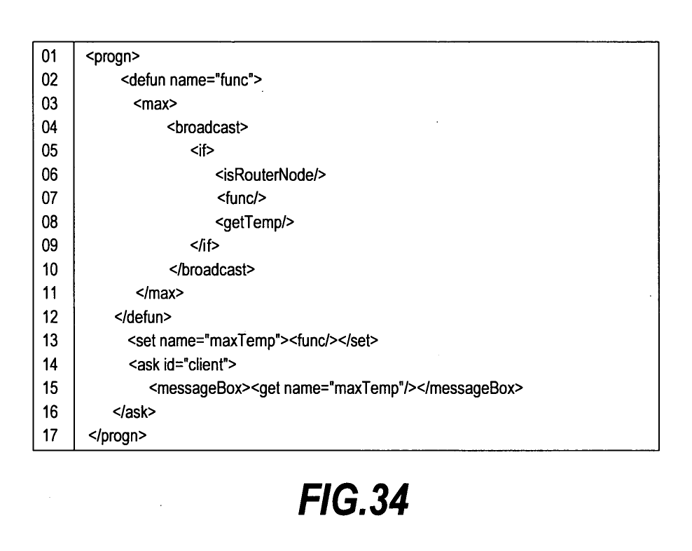

FIGS. 33 and 34 each show an eighth embodiment, which is an example of searching for sensor nodes, making an observation request, and collecting results by executing a script at the router node in the first embodiment. Other components are similar to those of the first embodiment.

FIG. 33 shows a network in which sensor nodes 3401 to 4, 3408 and 3412 and router nodes 3405 to 7, 3409 to 11, 3413 and 3414 are connected Ad-Hoc. The Ad-Hoc sensor network, is a sensor network, in which a server 3415, the sensor nodes, and the router nodes are connected by radio, and presence of adjacent nodes in a communication range can be detected, but the server 3415 cannot understand the entire configuration because a configuration of the sensor nodes and the router nodes is dynamically changed.

In a case where each sensor node has a temperature sensor, when a user makes a request “to know maximum value of temperature of the area”, it is necessary to search for a sensor node present in the area, execute observation by the sensor node, and calculate a maximum value of its result, to thereby meet with the user's request.

A script for realizing the above-described request can be realized as shown in FIG. 34. A user definition function func is defined by a defun command of a 2nd line. The function func accesses itself in a recursive manner at a 7th line. A maximum temperature which is an execution result of the func function is stored by a set command in variable maxtemp at a 13th line, and the maximum temperature is transmitted to a client 3416 at a 14th line.

A max command of a 3rd line selects a child which takes a maximum value among one or more children. A broadcast command of a 4th line transmits partial scripts which are children to all the adjacent nodes in a communication range. To prevent a loop, double reception of scripts having identical action ID's is rejected. An isRouterNode command of a 6th line returns true in the case of a router node.

By executing a script of FIG. 34 at the server 3415, 5th to 9th which are children of the broadcast command are transferred to the router nodes 3411 and 3414. The router node 3411 returns true to the isRouteNode command, the 7th line is executed, lines that follows the 2nd line are executed in a recursive manner, and the 5th to 9th lines which are children of the broadcast command are transferred to the router nodes 3407 and 3410 and the server 3415. To prevent a loop, communication of the server 3415 is ignored. By repeating this in a recursive manner, the partial scripts reach the sensor nodes 3401 to 3404, 3408 and 3412. The sensor node returns false to the isRouterNode, and a getTemp command which is a temperature observation command of the 8th line is executed. A result thereof becomes a return of the broadcast command, a maximum value is selected by a max command at the router node on the search route, and lastly a maximum value of the observed temperatures of all the sensor nodes is returned to the server 3415.

Thus, by using a reflexive structure at a script purser of this invention, it attains a compact description of the behavior of the router node to search for the sensor node, the behavior of the sensor node to observe the temperature, and the behavior of the router node to integrate the returns. By variously changing the isRouterNode of the 6th line, various route search algorithms can be mounted, e.g., prevention of use of a router node of a small battery residual. Continuous observation can be carried out by changing the getTemp command of the 8th line to an asynchronous event standby command whenever. As this operation is described in the script, it is possible to realize various operations according to user requests.

<Ninth Embodiment>

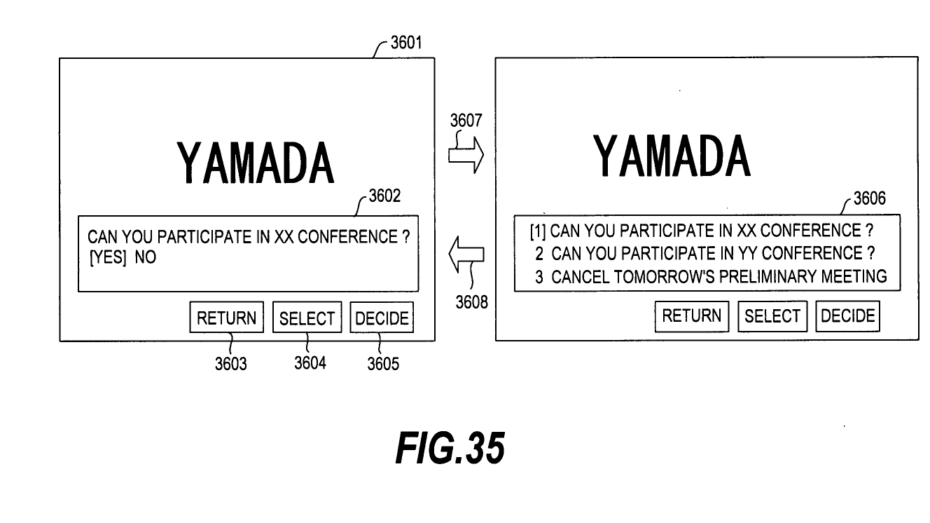

FIG. 35 shows a ninth embodiment, which is an example of a user interface in the sensor node 201 of the first embodiment.

FIG. 35 shows an example of a user interface in the sensor node 201 when the sensor node 201 is a name tag node as a simple communication tool for humans.

A name tag node 3601 is a type of a sensor node 201 of FIG. 2, and a sensor node which also serves as a human name tag. The name tag node 3601 is carried by a human, and has a function of detecting human intension expressed through pressing a button. The name tag node 3601 includes a display device 3602 such as a liquid crystal screen for displaying a question, response buttons (return button 3603, selection button 3604, deciding button 3605), and a function of communicating with a router node 202 and a server 203 by radio. It may further include a buzzer function, a vibration function or a lamp function such as an LED, for notifying arrival of a question from another node to a user. Additionally, by using the nature of the sensor node carried by the human, temperature and humidity sensors for measuring an environment, acceleration sensor for measuring a human behavior, and the like, may be added.

When a question is issued from another human (or node), the question and a response list are displayed as in the case of the screen 3602. The human presses the selection button 3604 by a plurality of times to select a response from the response list, and presses the deciding button 3605 to decide the response. When a plurality of questions are issued, the return button 3603 is pressed to display a list of unanswered questions on the screen 3606 by state transition 3607. The selection button 3604 is pressed by a plurality of times while the question list is being displayed, the deciding button 3605 is pressed to decide a question to answer, and the processing can return to the screen 3602 by state transition 3608.

The name tag node needs a function of holding a plurality of questions as shown on the screen 3606. The sensor network that includes the name tag node needs a function of properly distributing a response to a question to a person who has made the question.

By applying this invention, the sensor network that includes the name tag node can be realized. It is only necessary to mount the script manger 901 of the first embodiment on the name tag node, and to issue a question response request command which is an asynchronous command having a function of “displaying question on screen, and standing by for response button pressing event by human” as a child of the asynchronous communication command ask of FIG. 19C to the script manager 901. An operation sequence is similar to that of FIG. 20A to FIG. 20C. According to this invention, a script of a server side which has made the question can be identified by the action ID 113 of the return 116 of FIG. 3. Thus, a response to the question can be properly distributed to the questioner.

Furthermore, as a child of a communication command ask to the name tag node, a question response request command is recursively created in a tree form in combination with the condition determination command if 1907 of FIG. 18C. Thus, complex processing such as requestioning according to a question response can be easily mounted.

<Tenth Embodiment>

FIG. 36 shows a tenth embodiment where a gateway node is disposed as a router node in each room of a building, a sensor node is disposed below the gateway node, a server for controlling the gateway node is disposed, and home electric appliances (e.g., air conditioner) are disposed as actuator nodes.

Referring to FIG. 36, a sensor network system that includes a gateway node 3707, a server 3710, and an air conditioner node 3708 is arranged. The gateway node 3707 communicates by radio with a mobile node 3704 as a node having functions of a sensor node and a client carried by a human through radio communication.

The air conditioner node 3708 as an actuator node is connected to the air conditioner, and has a function of maintaining the inside of the room at a designated temperature and humidity by a proper command. When a user 3703 who carries the mobile node 3704 arrives in the building, the sensor network system controls the air conditioner node 3708 at a temperature according to a preference of the user 3703.

According to the tenth embodiment, the server 3710 corresponds to the server 203 of the first embodiment, the gateway nodes 3707 and 3708 correspond to the router node 202, the mobile nodes 3704 and 3705 correspond to the sensor node 201 and the client 205, and the air conditioner node 3708 corresponds to the actuator node 208. Other components are similar to those of the first embodiment.

This function is realized by the following method. A script of “control air conditioner at temperature and humidity according to a preference (e.g., 18° C.) of user 3703”) is first registered in the mobile node 3704, and the mobile node 3704 issues the script to the server 3710 via the gateway node 3707 according to a connection event from the gateway node 3707 to the mobile node 3704. The server 3710 executes the script to operate the air conditioner node 3708 at the designated temperature and humidity.

When this function is realized by the conventional sensor network, the sensor network manager must pre-register this function as the event handler of the server 3710. Therefore, it has been necessary to carry out temperature control according to average preferences rather than user's individual preference, or to pre-register a user's preference in the server 3710. By using this invention, it is only necessary to register the script manager alone of the invention in the server 3710 or the air conditioner node 3708. This application is useful for a special situation unpredictable by the sensor network manager, for example, in a case where the user 3703 has asthma or a cold, or an immature baby.

<Eleventh Embodiment>

FIG. 36 shows an eleventh embodiment where a gateway node is disposed as a router node in each room of a building, and a server for managing the gateway node is disposed. A gateway node 3707 communicates by radio with a mobile node 3704 as a node having functions of a sensor node and a client carried by a human through radio communications.

It is presumed that there are employees 3703 and 3706 who need to consult with each other. Both employees 3703 and 3706 make many business trips and are thus too busy to adjust a schedule of meeting. If it can be found that both employees 3703 and 3706 are accidentally at the same destination of the business trip, they can consult with each other there, which would increase business efficiency. Conventionally, such a chance has not been effectively used.

This function is realized by the following method. A script of “when mobile node 3705 of user 3706 is connected to sensor network, notify it to mobile node 3704” is first registered in the mobile node 3704, and the mobile node 3704 issues the script to a server 3710 via a gateway node 3707 according to a connection event from the gateway node 3707 to the mobile node 3704.

The server 3710 executes the script to stand by for connection of the mobile node 3705. The user 3706 arrives, the connection event from the mobile node 3705 is received by the event standby command of the script, and an action execution completion event is issued to the mobile node 3704. The script is received by the mobile node 3704 and presented to the user 3703, whereby the user 3703 can know the arrival of the user 3706.

When this function is realized by the conventional sensor network, the function must be pre-registered in event handlers of servers 3710 of all business trip places likely to be visited by employees. However, the conventional sensor network has had no such function of registering an individual request, and pre-registration in all the business trip places has not been realistic because of a processing load of the server 3710.

By script modification, this function can be easily expanded to a rule of “when arrival of user 3706 is checked, ask user 3706 about meeting, and notify to user 3704 if OK”. It is only necessary to register the interface of the name tag node and the question response request command of FIG. 35 in the mobile node 3705, to issue the question response request command as response processing of a connection event from the mobile node 3705 to the mobile node 3705, and to issue an action execution completion event to the mobile node 3704 only when a result is acceptance.

<Twelfth Embodiment>

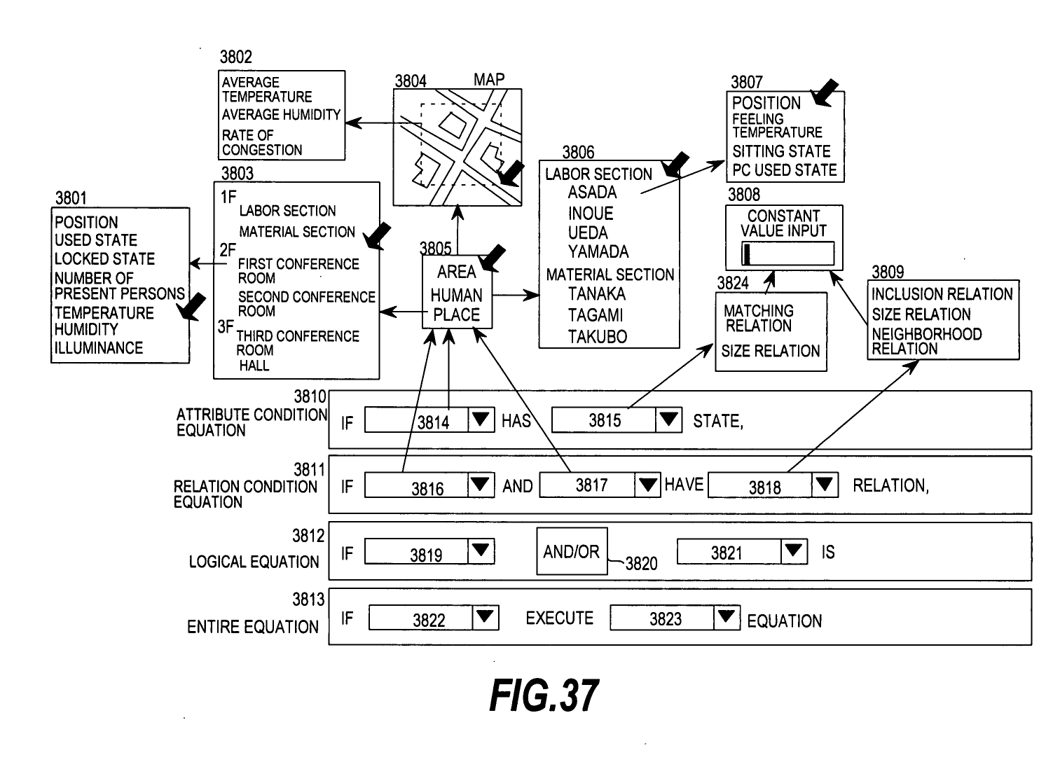

FIG. 37 shows a mounting example of a user interface in the client 205 of FIG. 2. A user interface for generating a script will be described.

On the script generation screen of the client 205 of FIG. 2, an attribute condition equation setting screen 3810, a relational condition equation setting screen 3811, a logical equation setting screen 3812, and an overall equation setting screen 3813 are displayed in a table form.

The attribute condition equation setting screen 3810 has pull-down menus 3814 and 3815, and shows a condition equation established when “designated object or its attribute” 3814 becomes “designated state” 3815. The relational condition equation setting screen 3811 has pull-down menus 3816, 3817 and 3818, and shows a condition equation established when “designated object or its attribute” 3816 and “designated object or its attribute” 3817 have “designated relation” 3818. The logical equation setting screen 3812 has pull-down menus 3819, 3820 and 3821, and shows a condition equation established when “designated condition” 3819 and “designated condition” 3821 are established by “logical or or logical end” 3820. For the “designated condition”, one of the condition equation 3810, the relational condition equation 3811, and the logical equation 3812 is selected. The overall equation setting screen 3813 has pull-down menus 3822 and 3823, and sets execution of “designated action” 3823 when the “designated condition” 3822 is established. Data displayed in each pull-down menu is obtained from a database (not shown) of the server 3710.

On the script generation screen, the overall equation setting screen 3813 alone is described in an initial state. By user's condition adding operation, an attribute condition equation 3810, a relational condition equation 3811, and a logical equation 3812 can be optionally added.

To realize easy user setting, a method of hierarchically displaying screens by user's selecting operation when the user selects the pull-down menu is conceivable.

The pull-down menus 3814, 3816, and 3817 all designate objects or attributes thereof. First, a schema display screen 3805 is displayed to select a type of an object. For example, types of objects are a place (facility name), an area, and a human. When the user selects the place, a place selection screen 3803 is displayed to select a place.

When the user further wishes to set attributes of the place, an attribute selection screen 3801 is displayed to select attributes of the place. When the user selects the area on the screen 3805, a map is displayed as an area selection screen 3804, and a rectangle or a polygon is input by a mouse to select the area. When the user further wishes to set attributes of the area, an attribute selection screen 3802 is displayed. When the user selects the human on the screen 3805, a human selection screen 3806 is displayed to select the human. When the user further wishes to set attributes of the human, an attribute selection screen 3807 is displayed to select attributes of the human.

On the pull-down menu 3815, a state of an object or attributes is designated. First, a relation selection screen 3824 is displayed to cause the user to select a relation, and then a constant value input screen 3808 is displayed to input a value. Similarly, on the pull-down menu 3815, a relation between two objects or attributes is designated. First, a relation selection screen 3809 is displayed to cause the user to select a relation, and then a constant value input screen 3808 is displayed to input a value.

By using such a graphical user interface, it is possible to collect pieces of information for generating a script.

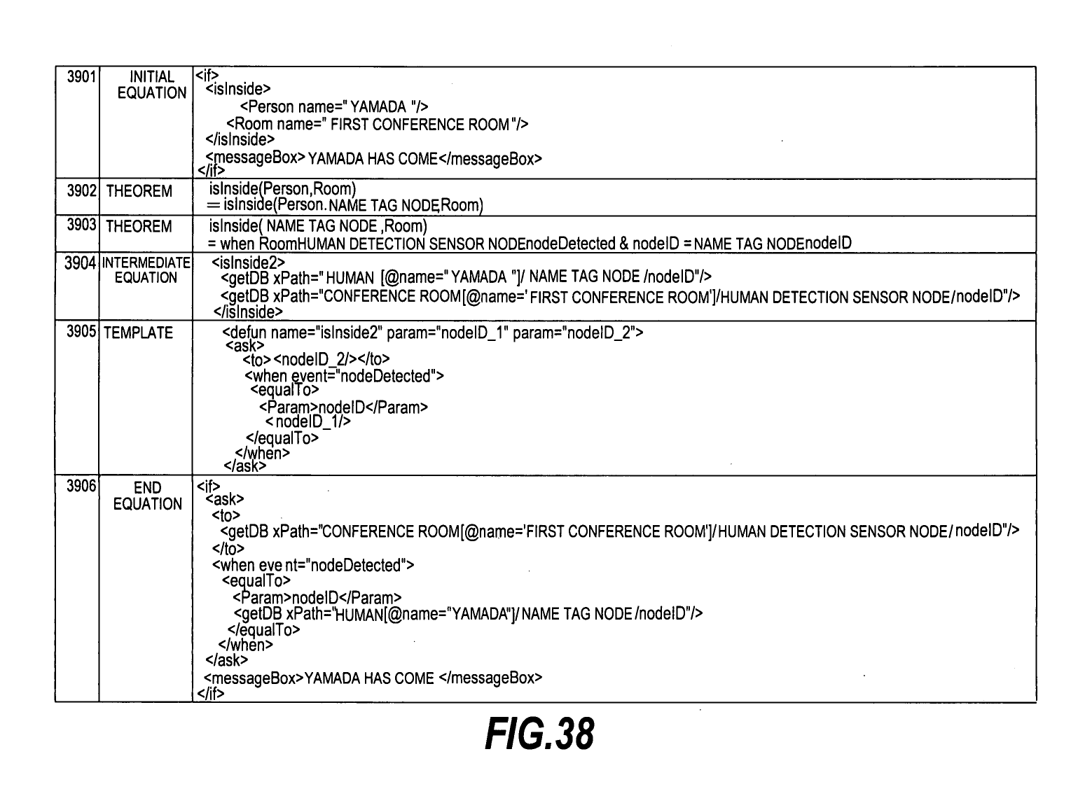

Referring to FIG. 38, as a mounting example of the server 3710 of FIG. 36 or the server 203 of FIG. 2, a method of converting a user request input by the user interface of FIG. 37 into a script will be described.

Referring to FIG. 38, it is presumed that a script 3901 is a user request input by the user interface of FIG. 37. For example, this is obtained by setting where the relational condition equation setting screen 3811 of FIG. 38 is used to select “Yamada” on the screen 3806 for the pull-down menu 3816, “First Conference Room” is selected on the screen 3803 for the pull-down menu 3817, “Inclusive Relation” is selected on the pull-down menu 3818, the overall equation setting screen 3813 is used to select the relational equation condition 3811 for the pull-down menu 3822, and a message of “Yamada has come” is displayed in the pull-down menu 3823. The script 3901 is in declarative language, and describes a user request only. There is no explanation as to how to execute. This is set as an initial equation, and conversion is made into an end equation 3906. The end equation 3906 describes that “a node ID of a human detection sensor node present in a conference room named first conference room is obtained from the database according to conditions designated by XPath, execution of a partial script is request to the node ID, and the node ID has contents of “when node detection event is detected, make determination as to whether a node ID of the detected node is equal to the node ID of the name tag node which a human named Yamada has”, and when its result is returned, a message of “Yamada has come” is displayed”.

This can be realized by allocating theorems 3902 and 3903 to the initial equation 3901. The theorems 3902 and 3903 are stored in the database 712 of the server shown in FIG. 5. The theorem 3902 indicates a logic of “human is in room≡name tag node of human is in room”, and the theorem 3903 indicates a logic of “name tag node is in room≡name tag node is detected by human detection sensor in room”. Accordingly, a command below islnside of the initial equation 3901 is unfolded in an intermediate equation 3904. A command iIndside2 used in the intermediate equation 3904 is defined as a template 3905. As a result, the initial equation 3901 can be unfolded in the end equation 3906. Thus, the manager of the server 203 prepare the theorems 3902 and 3903 and the template 3905, whereby the initial equation 3901 of the declarative language can be changed into the end equation 3906 of a procedural language as requested by the user. A target result can be obtained by executing this end equation 3906.

<Thirteenth Embodiment>

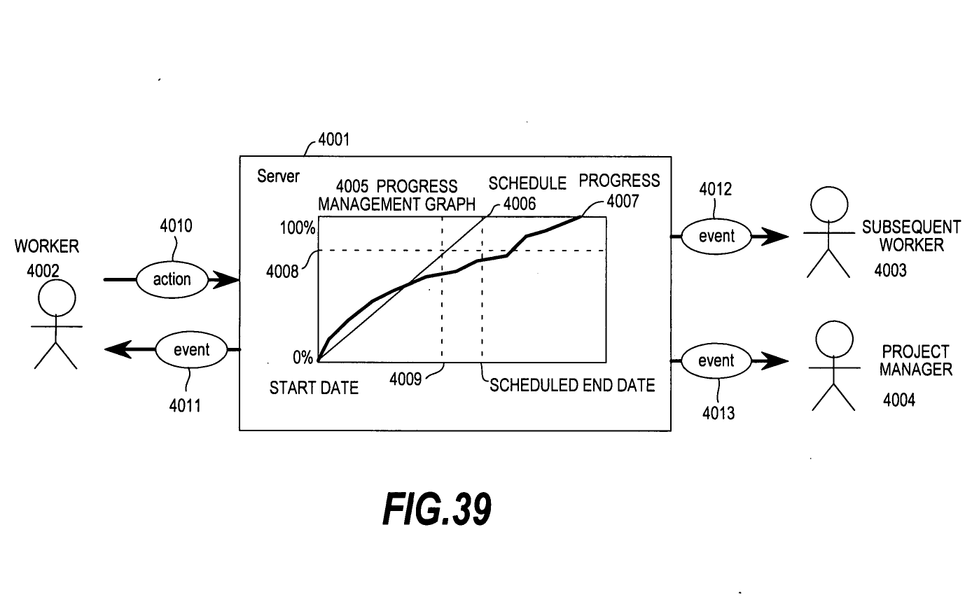

FIG. 39 shows an example according to the thirteenth embodiment when applying the sensor network of the first embodiment to a project management system for executing progress management.

Generally, in a project management field, a scheme such as Theory of Constraints (TOC) has progressed to present various project management systems. However, the conventional project management system has always been a static and passive system designed to assist the project manager. By applying this invention, it is possible to build a dynamic and active project management system.

Referring to FIG. 39, a function of the project management system of this invention will be described. A server 4001 for executing project management uses a progress management graph 4005 to manage a progress of each business constituting a project. In the progress management graph 4005, a schedule curve 4006 calculated from necessary days of business predicted beforehand by a project manager 4004, and a progress curve 4007 indicating an actual progress of the project are managed. A worker 4002 in charge of the business periodically updates the progress curve 4007 by an action 4010.

By applying this invention, various event handling operations can be carried out. For example, when a business progress is constant, a point of time when a certain ratio 4008 is exceeded is detected as an event, and an event is issued to a worker 4003 of a subsequent business, whereby a start day of the subsequent business can be notified. A point of time when the progress of the project is delayed by certain days from a scheduled date is detected as an event, and an event 4011 is issued to the worker 4002 or an event 4013 is issued to the project manager 4004, whereby countermeasures of business delays can be requested. Similarly, certain days 4009 before a scheduled business end day are detected as an event. When the progress of the project is delayed from a scheduled date, an event 4011 is issued to the worker 4002, or an event 4013 is issued to the project manager 4004, whereby countermeasures of business delays can be requested. When the worker 4002 does not execute a progress registration action 4010, nonexecution of the registration action 4010 is determined by a timer event, an event 4011 is issued to the worker 4002 to request an input, or an event 4013 is issued to the project manager 4004 to request countermeasures.

<Supplement>

The script manager which is the script execution engine of the first embodiment is installed in all of the sensor node 201, the router node 202, the server 203, the WEB service 204, and the client 205 constituting the sensor network of FIG. 2, or one of the nodes to execute event handling. Though omitted in FIG. 1, a plurality of router nodes 202 may be serially disposed.

According to the first embodiment, the script manager may be removed from the node in which event handling is unnecessary. When the script manager 404 is removed from the sensor node 201, the sensor node 201 issues a fixed event. When the script manager 409 is removed from the router node 202, event integration procession on the communication route is not executed. When script managers are removed from the server 203, the WEB service 204, and the client 205, event handing is not executed at each device. Thus, it is only necessary to mount a script manager on a node in which event handling is necessary.

As described above, according to this invention, the operation flow of the distributed event handling on the sensor network can be dynamically changed at optional time corresponding to the dynamically changed user object, whereby diverse user objects can be reflected on a single sensor network. Thus, as installation/maintenance costs can be shared among a plurality of users, it is possible to realize a large sensor network infrastructure for observing a wide environment.

While the present invention has been described in detail and pictorially in the accompanying drawings, the present invention is not limited to such detail but covers various obvious modifications and equivalent arrangements, which fall within the purview of the appended claims.

What is claimed is:

1. A sensor network system comprising:
a sensor node that transmits an event to an upper node based on observed information;
a client node that transmits a preset script to a lower node and receives the event from the sensor node; and
an intermediate node that mediates communication from the sensor node to the client node,
wherein, the client node includes a first script manager which executes scripts having processing preset for a plurality of nodes, extracts a script for a lower node, and distributes the script extracted to the lower node,
the intermediate node includes a second script manager which executes the script distributed by the first script manager, executes control over the intermediate node, extracts a script for a lower node, and distributes the script extracted to the node, and
the sensor node includes a third script manager which executes the script distributed by the second script manager to transmit the event based on the observed information to the upper node.

2. The sensor network system according to claim 1, wherein
the scripts include a script for the lower node as a partial script in a nested structure,
the first script manager extracts a partial script for a node lower than a self node, and distributes the partial script to the lower node, and
the second script manager extracts a partial script for a node lower than a self node, and distributes the partial script to the lower node.

3. The sensor network system according to claim 1, wherein
the scripts and partial scripts are described as commands of a tree structure, and
the first to third script managers execute all child commands in order of appearance before executing parent commands equivalent to roots of the tree structure, and substitute an execution result of the child commands with data to set the data as an argument for the parent commands.

4. The sensor network system according to claim 3, wherein
the commands include asynchronous commands that immediately finishes in uncompleted states without waiting for execution completion of the commands,
the first to third script managers include action handlers which finish parent commands of child commands in uncompleted states after a command is issued to execute the child commands when the asynchronous commands are executed as the child commands, and stand by until execution results are returned from the child commands, and
the action handlers resume the execution of the parent commands finished in the uncompleted states upon the return of the execution results from the child commands.

5. The sensor network system according to claim 4, wherein
the action handlers set command identifiers uniquely decided in the scripts for the asynchronous commands to be provided to the child commands of the asynchronous commands,
the child commands return the execution results together with the command identifiers when the execution results are returned to the action handlers, and
the action handlers resume the execution of the parent commands from command positions identified by the command identifiers from the child commands.

6. The sensor network system according to claim 3, wherein
the commands include parallel commands that execute the child commands of the commands in parallel, and
the first to third script managers execute all the child commands irrespective of finished states of the child commands when the parallel commands are executed as the child commands.

7. The sensor network system according to claim 4, wherein
the first to third script managers include action handlers which scan the tree structure in order of child-to-parent of the parent commands of the asynchronous commands at a point of time when the asynchronous commands appear, execute all younger brothers of commands having the asynchronous commands as descendents among the child commands of the parallel commands in order of appearance when the parallel commands that execute the child commands in parallel are present in the parent commands, and then store the tree structure to finish the scripts, and
the action handlers resume processing of the parallel commands at a point of time when the asynchronous commands of all the child commands of the parallel commands are returned, and enable execution of other commands before the asynchronous commands are returned.

8. The sensor network system according to claim 5, wherein
the asynchronous commands include communication commands that communicate with other nodes,
the first to third script managers include action handlers which finish parent commands of the communication commands in uncompleted states after transmitting the communication commands as child commands, the command identifiers and identifiers of the nodes to a communication destination node, and stand by until execution results are returned from the communication destination node, and
the action handlers resume execution of the parent commands corresponding to the command identifiers finished in the uncompleted states upon the return of the execution results and the command identifiers from the communication destination node.

9. The sensor network system according to claim 6, wherein
the parallel commands include deadline commands that request responses from a plurality of nodes, and
the first to third script managers resume commands only for those of the response requested nodes which give returns by a point in time after a preset time, and ignore other returns.

10. The sensor network system according to claim 1, wherein the intermediate node comprises:
a node search unit which searches for a sensor node described in the script;
a route search unit which searches for an optimal route from the searched sensor node to the intermediate node; and
an optimization unit which optimizes the scripts based on the sensor node searched for by the node search unit and the route searched for by the route search unit.

11. The sensor network system according to claim 10, wherein the optimization unit replaces noncommunication commands with communication commands when an exchange law is established between the noncommunication commands and the communication commands in a case where the scripts include the communication commands in child commands whose parent commands are noncommunication commands, and subsequently executes the child commands.

12. The sensor network system according to claim 10, wherein
the node search unit selects a group of sensor nodes sufficient for request accuracy from a plurality of sensor nodes present in a designated space area, and
the route search unit selects an optimal route of the intermediate node to reach the specific group of sensor nodes selected, and applies a connection law and the exchange law to integrate observation results of the group of sensor nodes in the space area.

13. A sensor network system which transmits a preset script from a self node to a lower node, and receives an event from the lower node,
wherein the self node includes a script manager which extracts a partial script for the node lower than the self node to distribute the partial script to the lower node, and executes a script for the self node,
the script manager includes an action handler which issues a command of execution to child commands when asynchronous commands are executed as the child commands in a case where scripts described as commands of a tree structure include the asynchronous commands that immediately finishes in uncompleted states without waiting for execution completion of the commands, then finishes parent commands of the child commands in uncompleted states, stand by until execution results are returned from the child commands, and resumes execution of the parent commands finished in the uncompleted states upon the return of the execution results from the child commands,
the action handler sets command identifiers uniquely decided in the scripts for the asynchronous commands to be provided to the child commands of the asynchronous commands,
the child commands return the execution results together with the command identifiers when returning the execution results to the action handler, and
the action handler resumes the execution of the parent commands from command positions identified by the command identifiers from the child commands.

14. A data processing method of a sensor network which sequentially transmits pieces of information observed by a sensor node as events to an upper client node from an intermediate node, comprising:
causing the client node or an upper node of the intermediate node to extract a script for a lower node from scripts having processing preset for a plurality of nodes, and to distribute the script extracted to the lower node;
executing processing for a self node from the script;
causing the lower node to receive the script distributed to execute processing for the lower node; and
causing the lower node to extract a script for a node lower than the self node from the scripts to distribute the script extracted to the lower node when the script for the lower node is present.

15. The data processing method of the sensor network according to claim 14, wherein
the scripts include the script for the lower node as a partial script in a nested structure, and
the script distributing step extracts a partial script for the node lower than the self node, and distributes the partial script to the lower node.

16. The data processing method of the sensor network according to claim 15, wherein the scripts and partial scripts are described as commands of a tree structure, and
the step of distributing the script extracted includes:
executing all child commands in order of appearance before executing parent commands equivalent to roots of the tree structure, and a substituting an execution result of the child commands with data and passing the data as an argument for the parent commands.

17. The data processing method for the sensor network according to claim 16, wherein
the commands include asynchronous commands that immediately finishes in uncompleted states without waiting for execution completion of the commands, and
the step of executing processing for the self node or the node includes:
issuing a command of execution to the child commands when executing the asynchronous commands as the child commands;
finishing parent commands of the child commands in uncompleted states after issuing the command to the child commands;
standing by until execution results are returned from the child commands, and a step of resuming the execution of the parent commands finished in the uncompleted states upon the return of the execution results from the child commands.

18. The data processing method for the sensor network according to claim 17, wherein
the step of issuing the command of execution to the child commands includes a step of setting command identifiers uniquely decided in the scripts for the asynchronous commands to and providing the command identifiers to the child commands of the asynchronous commands, and
the step of resuming the execution of the parent commands includes: returning the execution results together with the command identifiers when the child commands returns the execution results to the action handlers; and
resuming the execution of the parent commands from command positions identified by the command identifiers from the child commands.

19. The data processing method of the sensor network according to claim 16, wherein
the commands include parallel commands that execute the child commands of the commands in parallel, and
the step of executing processing for the self node or the node includes a step of executing all the child commands irrespective of finished states of the child commands when executing the parallel commands as the child commands.

20. A sensor node comprising:
a sensor that detects an observation value of an environment; and
a control unit that transmits the observation value of the sensor to an upper node,
wherein the control unit includes:
a comparison unit which comparers the observation value of the sensor with a preset range of observation values;
an interruption generation unit which generates interruption when a result of the comparison satisfies predetermined conditions; and
a controller which executes predetermined processing upon reception of the interruption.
